(19) United States
(12) Patent Application Publication
(10) Pub. No.: US 2010/0170857 A1
(43) Pub. Date: Jul. 8, 2010

(54) Apparatus for filtering and/or conditioning and/or purifying a fluid such as water

(76) Inventors: Richard T. Williams, Uwchland, PA (US); Carl Beiswenger, Pottstown, PA (US)

Correspondence Address: JOHN F. A. EARLEY III;HARDING, EARLEY, FOLLMER & FRAILEY, P.C., P.O. BOX 750, VALLEY FORGE, PA, 19482-0750, US

(21) Appl. No.: 12/319,219

(22) Filed: Jan. 3, 2009

(51) Int. Cl. E03B 7/07; F24D 19/08; B01D 17/00; B01D 35/147; C02F 1/00

(52) U.S. Cl. 210/741; 137/544; 137/197; 210/136; 210/133; 210/134; 210/120

(57) ABSTRACT

An apparatus for filtering water has a valve head and a filtration/purification canister removably mountable thereon. Connecting the canister to the valve head automatically opens a check valve in the valve head to permit water to flow from the valve head into and through the canister, and then back to and through the valve head to an outlet port. Disconnecting the canister from the valve head automatically closes the check valve, stopping the flow of water. A bypass valve is provided in the valve head to permit a sanitizing solution to flow through the valve head and along the lines of the water distribution system to sanitize the system, while bypassing the canister. The outlet port may be directly connected to an appliance that uses water, to eliminate possible contamination that may occur when water is brought indirectly from the outlet port to the appliance instead.

### FIELD OF THE INVENTION

This invention relates to apparatuses for filtering and/or conditioning and/or purifying a fluid such as water, and more particularly concerns such apparatuses that use pressure vessels holding a cartridge, loose media, or the like for filtering and/or conditioning and/or purifying a fluid such as water. This invention also relates to various fluid distribution systems, such as potable water distribution systems for aircraft, for example.

### BACKGROUND OF THE INVENTION

Aircraft Potable Water Use—Adequate hydration is particularly important for comfortable air travel. Aircraft typically are crowded with thousands of passengers including babies, small children, handicapped and others passing through a commercial passenger aircraft during a single week. Both passengers and crews contribute to microorganism populations aboard aircraft and special precautions must be taken to minimize and avoid the possibility of bacteria and other microorganisms being transferred to others through the water distribution system. A primary sanitation defense mechanism is to maintain an adequate residual of chlorine, preferably free chlorine, within the water storage and distribution system. However, water is supplied to aircraft from many locations and varies widely in taste and sanitary quality. Furthermore, leading causes of water borne disease, worldwide, are relatively large but still invisibly small, parasitic cysts such as Giradia and Crypto which are not controlled by chlorination. These pathogens can reliably be removed by effective microfiltration.

Aircraft Water Distribution and Management—Typically, a water distribution system on aircraft comprises a water storage tank and a centralized distribution line with various branches or legs extending from the central distribution line to locations throughout the aircraft. Water is distributed from the storage tank throughout the aircraft to galleys, lavatories and other locations as needed for food and beverage preparation, and for personal hygiene during flights. Galleys include coffee makers, water boilers and other drinking water service points. Similarly, lavatories often include drinking water outlets and may be used for face and hand rinsing, cleaning teeth and short term medication.

Water filter/purifier units, each comprising a housing pressure vessel (usually stainless steel) and a filtration/purification cartridge, are installed in or near galleys and lavatories as part of the aircraft water distribution system to improve water quality for consumption and for food and beverage preparation. Space in galley and lavatory compartments is expensive and severely limited. Accordingly, water filter/purifier units usually are installed in “out of the way” locations often behind other more readily accessible equipment and bulkheads.

Sanitation Practices—To overcome the challenges of virus, bacteria, and larger organism transmission via water systems and colonization within the aircraft potable water distribution systems, airlines, in addition to trying to assure an adequate chlorine residual within the aircraft water supply, periodically sanitize their aircraft water distribution systems with a 2+ hours soak of high concentration (100 ppm) chlorine solutions. The sanitation process is time and labor intensive and, because such high concentrations of chlorine is detrimental to the filtration/purification cartridges, requires removing the filtration/purification cartridges from the water filter/purifier units installed in galleys, fountains and lavatories throughout the aircraft prior to the sanitation process. After removal of cartridges, the housings (pressure vessels) must be reassembled to seal against leakage during sanitation. After chlorine flushing and soaking, the housings (pressure vessels) once again must be accessed, opened and the same or new cartridges must be installed. The housings (pressure vessels) frequently are installed in hard to reach locations, resulting in expensive labor costs alone sometimes ranging upwards to hundreds of dollars per unit.

System Draining and Refilling—Water must be drained from aircraft during periods of non-use (such as overnight) in cold climates. Proposed EPA regulations require much more frequent draining and filling of water storage tanks in an effort to improve aircraft drinking water quality and safety. Draining and filling water systems requires “vacuum breaks” at equipment locations to allow water to be properly released and “vents” to allow air to escape in order to assure proper functioning of filters, purifiers, and other equipment. Although the very latest filter/purifier units include automatic vacuum breaks and venting, most aircraft units require manual actuation often resulting in inadequate water draining and filling.

Also, under the proposed EPA regulations, it is likely that accessing and actuating manual vents and vacuum breaks, sometimes previously ignored, may become a significantly higher maintenance cost item due to difficult access to the water filter/purifier units and aircraft “out of service” revenue costs.

Microorganism Growth—Even with periodic sanitization, bacteria may colonize various branches (legs) of water distribution systems. Bacteria multiply rapidly, sometimes doubling in number in approximately 16 minutes. Therefore, a small number of bacteria may quickly reach infectious concentrations in water intended to be consumed, especially downstream of improperly installed/serviced filters/purifiers employed to remove chlorine, foul tastes, and odors. Further, water filter/purifier units installed in semi-remote locations along the water distribution system often require longer than desired distribution lines to specific service points (e.g., locations where the water is discharged from the water distribution system). These distribution lines provide unnecessary opportunities for previously purified water to be recontaminated from inadvertent inoculation, short term bacteria multiplication or biofilm formation/shedding that may have taken place in such distribution lines downstream of the water filter/purifier units.

### SUMMARY OF THE INVENTION

It is an object of the invention to provide an apparatus for filtering and/or conditioning and/or purifying a fluid such as water.

It is another object of the invention to enable and introduce a new concept to provide more efficient, more cost effective, improved water quality management aboard passenger aircraft, and for other applications. For example, and more specifically with respect to passenger aircraft applications, the concept is to provide water filter and water purifier systems installed at various aircraft cabin crew readily accessible service locations (service points) within galleys and lavatories of the aircraft, preferably at or near where the water that is filtered and/or conditioned and/or purified for immediate use. This invention provides for various types of filtering and purifying processes being available in interchangeable self-contained canisters (e.g., pressure vessels 15, each containing filtration and/or purification media 16) attached to interfacing “valve heads” integrated into the water distribution system at appropriate cabin crew readily accessible locations. Stored water can then be filtered and/or purified immediately at the time and place of use as it is discharged from the potable water distribution system.

Another object of the invention is to provide an aircraft potable water distribution system having valve heads installed locally at various cabin crew readily accessible service locations or service points within galleys and lavatories of the aircraft, to connect an outlet port of at least one of the valve heads directly to an appliance such as a coffee maker or other water-using equipment located in the galley of the aircraft to reduce possible exposure of the water that has been filtered and/or conditioned and/or purified to contaminants that may be encountered if water were to be indirectly brought from the outlet port of the valve head to the appliance instead.

Still another object of the invention is to provide an apparatus and aircraft potable water distribution system that allows non-technical flight attendants servicing, that is, removal of filtration/purification cartridges, and replacement thereof, on a frequent basis as an extension of normal routines, without requiring professional maintenance crew attendance and support.

These and other objects are provided by our invention, a description of which is set out below.

### BRIEF DESCRIPTION OF THE DRAWINGS

FIG. 1 is an exploded view of the first end portion of the valve head 13, constructed in accordance with the invention.

FIG. 2 is an exploded view of the second end portion of the valve head 13, constructed in accordance with the invention.

FIG. 3 is a top plan view of the apparatus 11 of the invention.

FIG. 4 is a view in cross section taken along the lines and arrows 4-4 shown in FIG. 3.

FIG. 5 is a view in partial cross section taken along the lines and arrows 5-5 shown in FIG. 3, except that the canister or pressure vessel 15 is shown as a partial view in perspective and exploded away from the valve head 13.

FIG. 6 is a partial view in cross section taken along the lines and arrows 6-6 shown in FIG. 3.

FIG. 7 is a bottom plan view of the valve head member 13a of valve head 13.

FIG. 8 is a top plan view of the valve head member 13b of valve head 13.

FIG. 9 is a top plan view of a canister (the pressure vessel 15 containing a cartridge 16) of the invention.

FIG. 10 is a partial view in cross section showing an automatic venting device 239 formed in the bowl of an alternative embodiment of the pressure vessel, constructed in accordance with the invention.

FIG. 11 is an exploded view of the automatic venting device 239 shown in FIG. 10.

FIG. 12 is an enlarged view of a portion of the apparatus 11 shown in FIG. 4.

FIG. 13 is a view in bottom plan of the end cap 183 which has a hollow tube 187 that functions as the outlet port from the canister (the pressure vessel 15 having the cartridge 16 mounted therein).

FIG. 14 is a view in cross section taken along the lines and arrows 14-14 shown in FIG. 13.

FIG. 15 is a view in partial cross section showing an alternative bypass valve 261, in which the bypass valve 261 is in a closed position blocking flow through the third passageway 99 formed in the valve head 13. For purposes of clarity, various details relating to the valve head 13 are not shown in this figure so as to highlight the details relating to the bypass 261.

FIG. 16 is a view in partial cross section showing an alternative bypass valve 261, in which the bypass valve 261 is in a opened position to permit flow of fluid through the third passageway 99 formed in the valve head 13. For purposes of clarity, various details relating to the valve head 13 are not shown in this figure so as to highlight the details relating to the bypass 261.

FIG. 17 is a view in cross section of an end cap used to cover the second end portion of the valve head 13 when a canister is not connected to the valve head 13 to block dirt and other debris from having easy access to the second end portion 71 of the valve head 13.

FIG. 18 is a view in front elevation of a pressure vessel 15 that is provided with a reinforcement member 219 secured around the sealed seam portion 217 of the pressure vessel 15.

### DETAILED DESCRIPTION

Turning now to the drawings, there is shown the inventive apparatus 11 for filtering and/or conditioning and/or purifying a fluid, such as water. (Purification, per EPA regulations, requires performance meeting the EPA Guide Standard Protocol for Microbiological Purifiers; filtration and conditioning may be almost anything else that is useful, such as taste and odor removal, scale control, etc.)

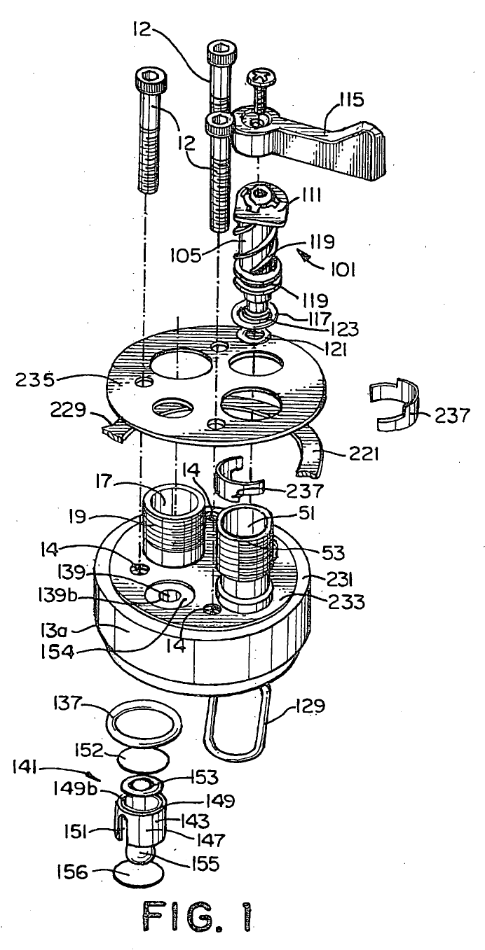

Referring particularly to FIGS. 1, 2, 4, and 12, apparatus 11 includes an automatic valving unit 13 for a pressure vessel 15 that holds a cartridge 16, or loose media, or the like for filtering and/or conditioning and/or purifying a fluid, such as water. The automatic valving unit 13 (also referred to herein as “valve head 13”), when desired, automatically provides for fluid flow into the pressure vessel 15 when the pressure vessel 15 is in use and, when desired, automatically discontinues fluid flow from the valve head 13 when the pressure vessel 15 is disconnected from the valve head 13.

The valve head 13, which preferably is machined from a metal such as stainless steel or aluminum preferably coated and sealed with a hard aluminum oxide coating for scratch resistance and long life, preferably includes a first end member 13a and a second end member 13b, which are held together by threaded bolts 12 that extend through bores 14 formed in and extending through the first end member 13a and into aligned threaded bores 18 formed in the second end member 13b.

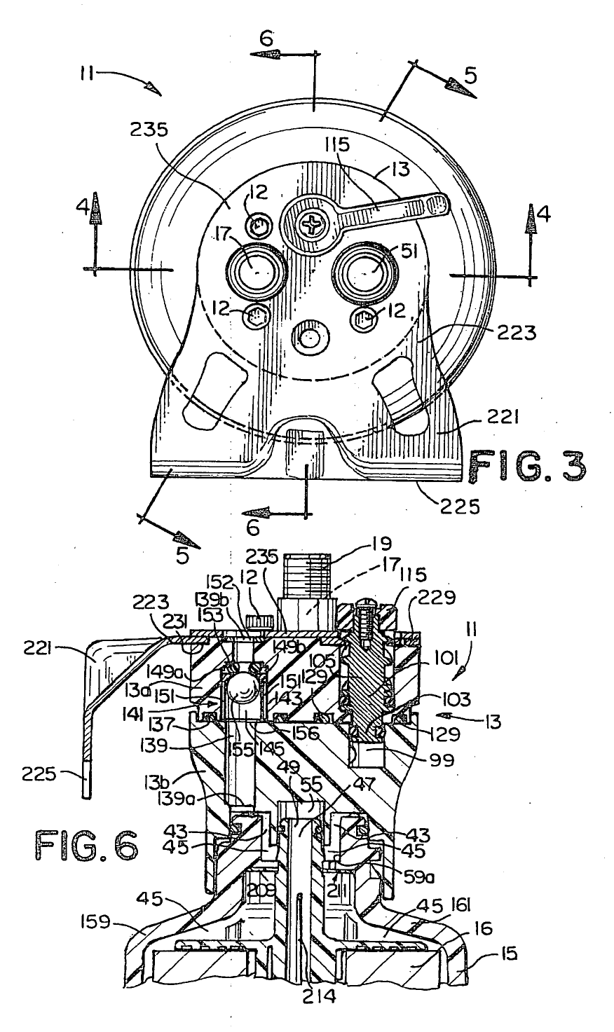

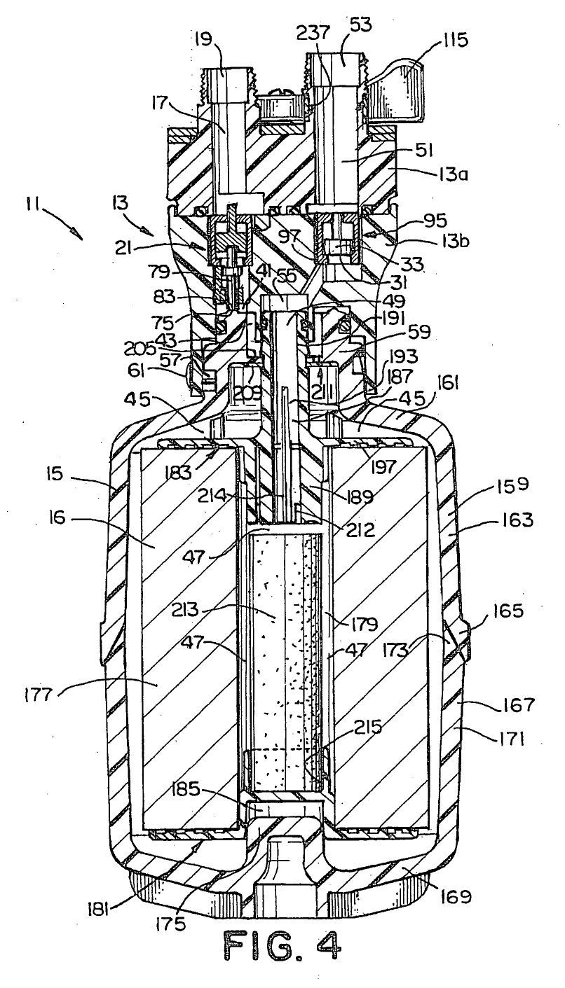

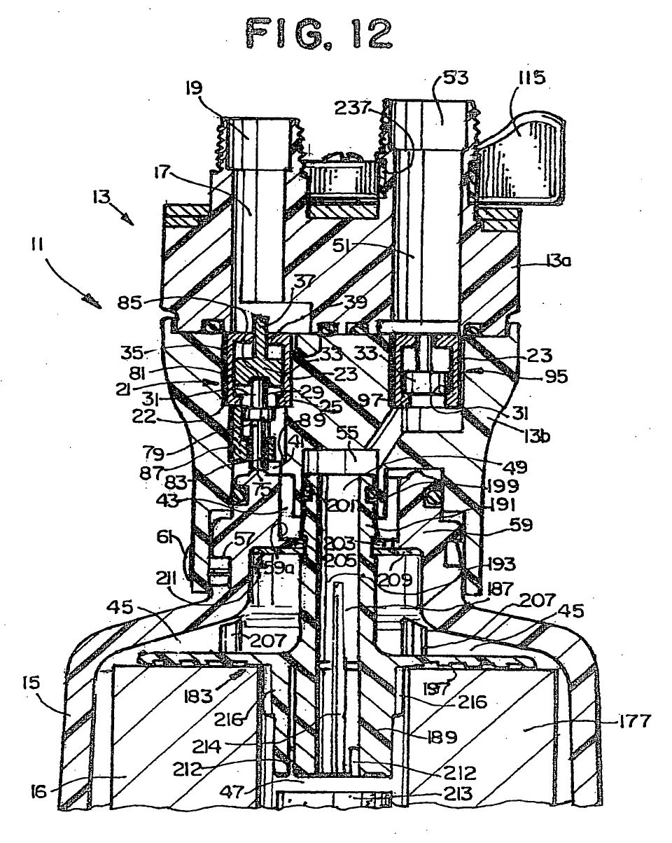

As shown in FIGS. 4 and 12, the valve head 13 has a first passageway 17 extending through it and adapted to be connected to a fluid transmission line, such as a water supply line of an aircraft potable water distribution system. Preferably, the valve head 13 has a threaded inlet port 19 at the entrance of the first passageway 17 that receives a threaded female fitting of the fluid transmission line.

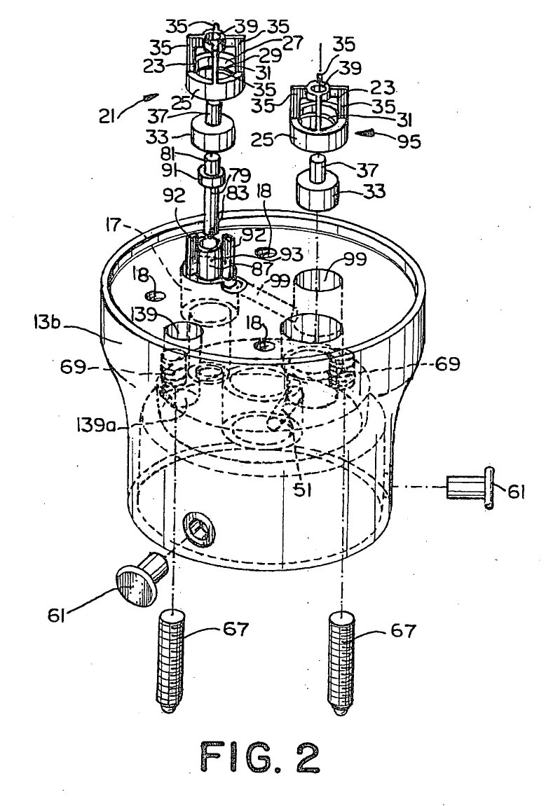

Referring particularly to FIGS. 12 and 2, a first check valve 21 is positioned on an annular ledge 22 formed in the first passageway 17 of the valve head 13 for blocking flow of fluid through the first passageway 17 when the valve 21 is closed. Preferably, the first check valve 21 includes a valve housing 23 (preferably made of a suitable polymeric material) having an annular ring-shaped base portion 25 that has an annular inner wall surface 27. An annular ledge 29 is formed on the inner wall surface 27 creating a valve seat 31.

A movable valve disc 33 (preferably made of a suitable polymeric material) is contained within the valve housing 23 that closes the valve 21 when the valve disc 33 rests against the valve seat 31 and that permits flow of fluid through the valve 21 when the valve disc 33 is not resting against the valve seat 31. The valve housing 23 also includes a plurality of arms 35 that extend away from the base portion 25 of the valve housing 23 and over the opening in the valve housing 23 formed by the annular ring-shaped base portion 25 to form a cage-like structure that contains the valve disc 33 in the valve housing 23. As shown in FIGS. 2, 4, and 12, the valve disc 33 has a guide pin 37 formed on and extending upstream from its upstream face that is engaged by and slides in a guide pin holder 39 (a small hollow cylinder) formed on the ends of the arms 35 where the arms 35 meet over the opening in the annular ring-shaped base portion 25 to keep motion of the valve disc 33 on a line that permits proper seating of the valve disc 33 on the valve seat 31.

An outlet port 41 is formed at the outlet end portion of the first passageway 17 of the valve head 13.

Referring to FIGS. 4 and 12, the pressure vessel 15 has an inlet port 43 that is in fluid communication with the outlet port 41 formed at the outlet end portion of the first passageway 17 in the valve head 13 when the pressure vessel is connected to the valve head 13. The pressure vessel 15 has a first passageway 45 extending from the inlet port 43 of the pressure vessel 15 to the cartridge 16, or loose media, or the like, through which the fluid passes to filter and/or condition and/or purify the fluid, and a second passageway 47 extending from the cartridge 16, or loose media, or the like to an outlet port 49 of the pressure vessel 15.

The valve head 13 also is provided with a second passageway 51 extending through it and adapted to be connected to a fluid receiving line (such as a water faucet of an aircraft potable water distribution system or an apparatus such as a coffee maker used on an airplane) at an outlet port 53 of the second passageway 51. Preferably, the outlet port 53 has a threaded fitting that is received in a threaded female fitting of the fluid receiving line.

The valve head 13 has an inlet port 55 formed at an inlet portion of the second passageway 51 in the valve head 13 that is in fluid communication with the outlet port 49 of the pressure vessel 15 when the pressure vessel 15 is connected to the valve head 13.

Referring to FIGS. 5, 12, and 2, connecting/disconnecting means is provided for connecting the pressure vessel 15 to the valve head 13, when desired, to permit flow of fluid from the first passageway 17 in the valve head 13 to the inlet port 43 of the pressure vessel 15, and for disconnecting the pressure vessel 15 from the valve head 13, when desired, to stop flow of fluid from the first passageway 17 in the valve head 13. Preferably, the connecting/disconnecting means comprises a bayonet-style mount, including a plurality of grooves 57 (three such grooves 57 being used in the embodiments of the invention shown in the drawings) formed on the neck 59 of the pressure vessel 15, and a corresponding number of pins 61 (three such pins 61 being used in the embodiments of the invention shown in the drawings) mounted on the valve head 13. Each groove 57 has a first end portion 63 where a corresponding pin 61 may be inserted and moved along the groove 57 by turning the pressure vessel 15 around its central axis until the pin 61 reaches a second end portion 65 of the groove 57, thereby securing the pressure vessel 15 to the valve head 13. A plurality of spring-loaded plungers or detents 67 (two such plungers 67 being used in the embodiments of the invention shown in the drawings) are screwed into threaded bores 69 formed in the second end member13b of the valve head 13 which push against the first end portion 73 of the neck 59 of the pressure vessel 15 when the pressure vessel 15 is connected to the valve head 13.

Alternatively, instead of grooves 57 and pins 61, the connecting/disconnecting means may comprise threads formed on the outer surface of the neck 59 and matching threads formed on the valve head 13, such as that disclosed in Williams U.S. Pat. No. 5,695,168, which is incorporated herein in its entirety by reference.

Referring again to FIGS. 2, 4, and 12, actuating means is provided for automatically opening the valve 21 when the pressure vessel 15 is connected to the valve head 13. Preferably, the actuating means includes a pin 79 that is positioned in the first passageway 17 of the valve head 13 between the valve disc 33 and the outlet port 41 at the outlet end portion of the first passageway 17 of the valve head 13. The pin 79 has a first end portion 81 and a second end portion 83, the first end portion 81 engaging the valve disc 33 by being received in a bore 85 formed in the downstream face of the valve disc 33, and the second end portion 83 being held by a pin holder 87 (positioned between valve 21 and an annular ledge 89 in the first passageway 17) in which the pin 79 is free to slide back and forth along the center axis of the pin 79. A radially extending ridge 91 is provided on the pin 79 to abut against a portion of the pin holder 87 to prevent the pin 79 from falling completely out of the first passageway 17 through the outlet port 41. The cross-section of the pin 79, even at the ridge 91, is smaller than the cross-section of the first passageway 17 so that fluid may flow through the first passageway 17 where the pin 79 is positioned when the valve 21 is open. Also, when the valve 21 is open, fluid may pass through the first passageway 17 where the pin holder 87 is located by passing between the spacing flanges 92 (three such spacing flanges 92 being used in the embodiments of the invention shown in the drawings), which surround and position a tubular section 93 (which holds the second end portion of the pin 79 in a sliding relationship) in the first passageway 17 in alignment with the valve disc 33.

The length of the pin 79 is such that when the pressure vessel 15 is connected to the valve head 13, the first end portion 73 of the neck 59 of the pressure vessel 15 pushes against the pin 79 causing the first end portion 81 of the pin 79 to push the valve disc 33 off and sufficiently away from the valve seat 31 to open the valve 21 to permit flow of fluid through the valve 21 and passageway 17.

Referring to FIGS. 5, 4, and 12, preferably, the actuating means also includes a cam or bump 75 formed on the first end portion 73 of the neck 59 of the pressure vessel 15, such cam 75 being located on the first end portion 73 of the neck 59 such that when the pressure vessel 15 has been connected to the valve head 13 (that is, when the pressure vessel 15 has been rotated into engagement with the valve head 13 such that the pins 61 have reached the second end portion 65 of the grooves 57), such cam 75 is aligned and in contact with the second end portion 83 of the pin 79 to push against the pin 79 causing the first end portion 81 of the pin 79 to push the valve disc 33 off and sufficiently away from the valve seat 31 to open the valve 21 to permit flow of the fluid through the valve 21 and the first passageway 17. In the embodiment of the invention shown in the drawings and especially in FIG. 5, the first end portion 73 of the neck 59 of the pressure vessel 15 has three such cams or bumps 75 spaced 120° apart from each other in a circle formed by the first end portion 73 of the neck 59 so that the pressure vessel 15 may be rotated onto the valve head 13 with either the first pin 61 engaging the first groove 57, the second pin 61 engaging the second groove 57, and the third pin 61 engaging the third groove 57, or the first pin 61 engaging the second groove 57, the second pin 61 engaging the third groove 57, and the third pin 61 engaging the first groove 57, or the first pin 61 engaging the third groove 57, the second pin 61 engaging the first groove 57, and the third pin 61 engaging the second groove 57, resulting in one of the three cams or bumps 75 being aligned with and pushing against the second end portion 83 of the pin 79 to cause the first end portion 81 of the pin 79 to push the valve disc 33 off and significantly away from the valve seat 31 to open the valve 21 to permit flow of fluid through the valve 21 and the first passageway 17 when the pressure vessel 15 has been connected to the valve head 13.

In the embodiments of the invention illustrated in the drawings, six indents 94 are formed in the first end portion 73 of the neck 59 spaced 60° apart from each other in a circle formed by the first end portion 73 of the neck 59, with three of the indents 94 being located adjacent to a corresponding bump or cam 75. When the pressure vessel is fully twisted onto the valve head 13 such that one of the bumps or cams 75 is aligned with and pushing against the second end portion 83 of the pin 79, one of the plungers 67 clicks into the indent 94 located adjacent to that bump or cam 75 that is aligned with and pushing against the second end portion 83 of the pin 79, and the other plunger 67 clicks into the indent 94 that is positioned directly across the neck 59 from the indent 94 that is adjacent to the bump or cam 75 that is aligned with and pushing against the second end portion 83 of the pin 79, to provide a tactile sensation or feel to the person twisting the pressure vessel 15 onto the valve head 13 indicating that the pressure vessel 15 has been properly connected to the valve head 13.

A second check valve 95 is positioned on an annular ledge 97 formed in the second passageway 51 of the valve head 13 for blocking backflow of fluid from the second passageway 51 of the valve head 13, especially when the pressure vessel 15 is not connected to the valve head 13. Preferably, the second check valve 95 includes a valve housing 23 which contains a movable valve disc 33, as described above for the first check valve 21. The flow of fluid from the pressure vessel 15 pushes the movable disc 33 of the second check valve 95 off the valve seat 31 of the second check valve 95 and moves it in the downstream direction away from the valve seat 31 of the second valve 95 to permit fluid flowing from the pressure vessel 15 to flow through the second valve 95 and through the second passageway 51 of the valve head 13 to the fluid receiving line connected to the outlet port 53 of the second passageway 51 of the valve head 13. However, backflow of fluid through the second passageway 51 of the valve head 13 is blocked by the second check valve 95 due to any backflow of fluid pushing the moveable disc 33 of the second check valve 95 onto the valve seat 31 of the second check valve 95, thereby causing the second check valve 95 to close.

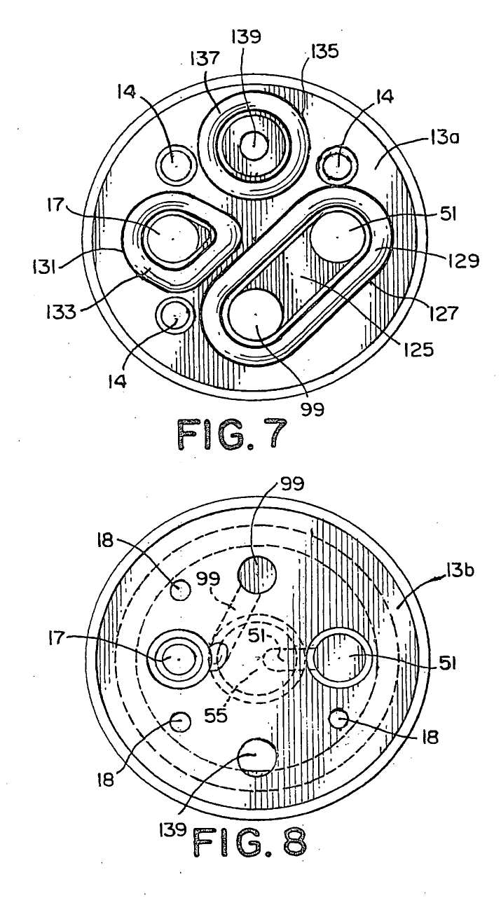

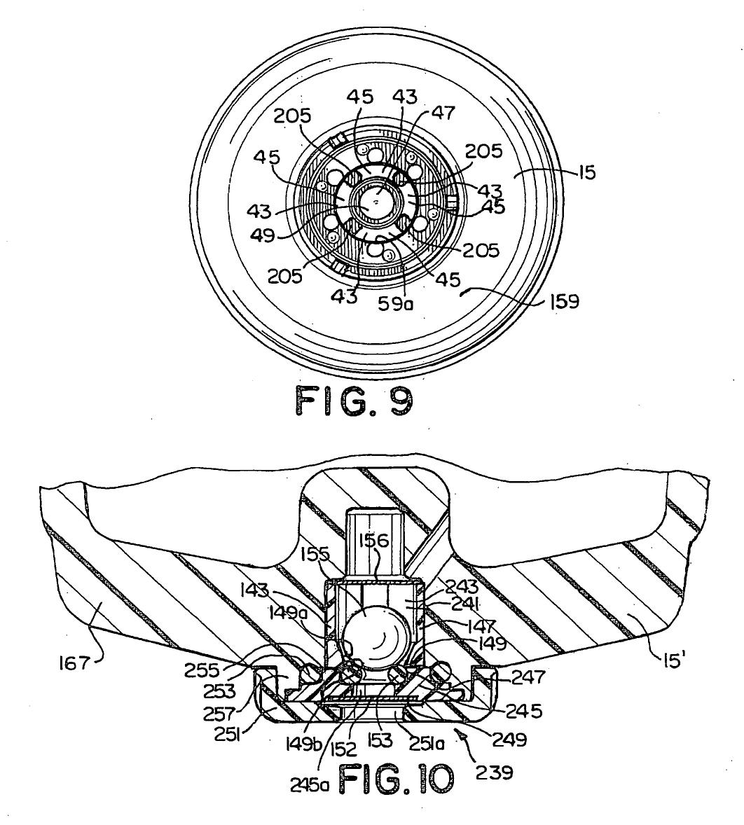

Preferably, but optionally, the valve head 13 also has a third passageway 99 formed in it that extends from the first passageway 17 at a position upstream of the first check valve 21 to the second passageway 51 downstream of the second check valve 95, and a bypass valve 101 positioned in the valve head 13 that has a portion 103 that when extended into the third passageway 99 blocks flow of fluid through the third passageway 99 and that when withdrawn from the third passageway 99 opens the third passageway 99 to permit fluid to flow through the third passageway 99. Referring to FIGS. 2, 5, 7, and 8, preferably, the third passageway 99 extends from the first passageway 17 at a position 17a located at the second end portion of the first end member 13a of the valve head 13 into the second end member 13b. The bypass valve 101 preferably includes a shaft 105 having a first end portion 107, a second end portion that forms the portion 103 of the bypass valve 101, and threading 109 on a portion of the shaft's length. A thread engaging member 111, such as a pin, a nubbin disc, or the like (a nubbin disc being shown in the drawings preferably secured to the valve head 13 in a recess 113 in the first end portion of the first end member 13a) is provided to engage the threading 109 of the shaft 105, and a handle 115 is mounted on the first end portion 107 of the shaft 105 for rotating the shaft 105 in a first direction to move the second end portion 103 of the shaft 105 from the third passageway 99 to permit flow of fluid through the third passageway 99 and for rotating the shaft 105 in a direction opposite to the first direction to move the second end portion 103 of the shaft 105 into the third passageway 99 to block flow of fluid through the third passageway 99. The bypass valve 101 preferably is positioned in a bore 116 that extends through the first end member 13a of the valve head 13 and into engagement with the third passageway 99 formed in the valve head 13. A first o-ring 117, positioned in an annular groove 119 that extends around the shaft 105, is provided to seal between the shaft 105 and the wall that forms the bore 116 to prevent the fluid from escaping from the valve head 13 through the bore 116. A second o-ring 121, positioned in an annular grove 123 that extends around the shaft 105 in its end portion 103, is provided to seal between the shaft 105 and the wall that forms the third passageway 99 when the portion 103 is positioned in the third passageway 99 to prevent fluid from flowing in the third passageway 99 past the portion 103.

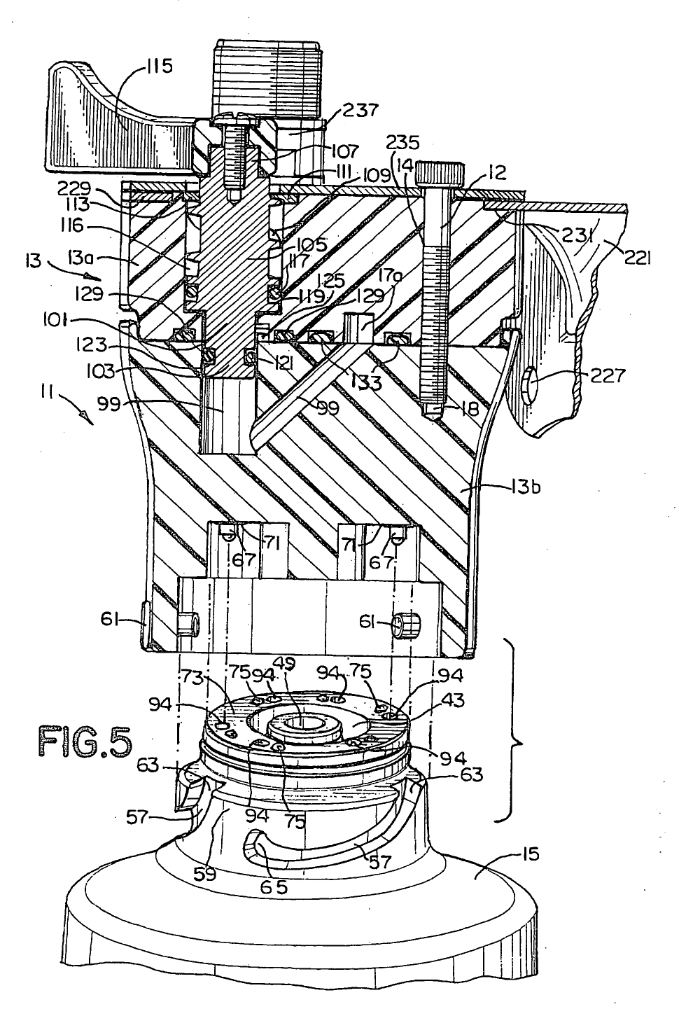

The third passageway 99 continues beyond the location of the bypass valve 101 along a groove 125 (FIGS. 5 and 7) formed in the second end portion of the first end member 13a of the valve head 13 that leads to the second passageway 51 in the valve head 13 downstream of the second check valve 95. A groove 127 (FIG. 7) also is formed in the second end portion of the first end member 13a of the valve head 13 that surrounds the groove 125, and an o-ring 129 is received in the groove 127 to seal between the second end portion of the first end member 13a and the first end portion of the second end member 13b around the groove 125 and to seal between the second end portion of the first end member 13a and the first end portion of the second end member 13b around the second passageway 51 along where the groove 125 intersects the passageway 51.

A groove 131 (FIG. 7) also is formed in the second end portion of the first end member 13a of the valve head 13 that receives an o-ring 133 that seals the first passageway 17 between the first end member 13a and the second end member 13b.

Referring to FIGS. 6 and 1, optionally, but preferably, the valve head 13 also has a fourth passageway 139 extending through it, and an automatic venting/vacuum breaking device 141 positioned therein for venting air contained in the apparatus 11 and for breaking any unwanted vacuum formed in the apparatus 11. The fourth passageway 139 has an inlet port 139a and an outlet port 139b. A groove 135 is formed in the second end portion of the first end member 13a of the valve head 13 that receives an o-ring 137 that seals the fourth passageway 139 between the first end member 13a and the second end member 13b. The automatic venting/vacuum breaking device 141 includes a vent sleeve 143 positioned in a chamber 145 formed along the fourth passageway 139. Vent sleeve 143 has a cylindrical wall 147 having an inwardly extending flange or ledge 149 formed at the downstream end portion of the vent sleeve 143, and a plurality of cutouts 151 (two being used in the embodiments of the invention shown in the drawings) formed in the wall 147 extending from the downstream end portion of the vent sleeve 143 toward the upstream end portion of the vent sleeve 143. The ledge 149 of the vent sleeve 143 has an upstream end portion 149a and a downstream end portion 149b, and each such end portion 149a and 149b preferably is chamfered. An o-ring 153 is positioned immediately downstream of the downstream end portion 149b of the ledge 149 and is blocked by the downstream end portions 149b of the ledge 149 from falling into the chamber 143. A ball 155 preferably having a density slightly greater than the density of the fluid (e.g., if water is the fluid, a preferred specific gravity for the ball 155 is about 1.1) is positioned in the vent sleeve 143 and permits venting of air contained in the apparatus 11 and breaking of any unwanted vacuum in the apparatus 11 until the fluid pushes the ball 155 into engagement with a portion of the o-ring 153 creating a seal between the ball 155 and the o-ring 153 and the o-ring 153 and the wall of the fourth passageway 139, thereby closing the fourth passageway 139. The diameter of the passageway 139 at chamber 145, the diameter of the cylindrical vent sleeve 143, and the diameter of the ball 155 are greater than the diameter of the passageway 139 upstream of the chamber 145.

A screen 152, positioned in a recess 154 formed in the first end portion of the first end member 13a and held therein by the cover plate 235 positioned thereover, and a screen 156, positioned in the chamber 145 upstream of the vent sleeve 143, are provided to reject possible interfering debris or particulates.

Referring to FIG. 4, the pressure vessel 15 includes a cover 159 having a top wall 161 and a side wall 163, which has a lower end portion on which a cover rim 165 is formed. The pressure vessel 15 also includes a bowl 167 having a bottom wall 169 and a side wall 171, which has an upper end portion on which a bowl rim 173 is formed.

In the embodiments of the invention illustrated in the drawings, the means for filtering and/or conditioning and/or purifying a fluid comprises a cartridge 16. As shown in FIG. 4, preferably, the cartridge 16 comprises a cylindrical microfiltration matrix 177 for filtering and/or conditioning and/or purifying a fluid passing through it. The matrix 177 has a cylindrical channel 179 along its center axis that receives the fluid after it has passed through the matrix 177, the channel 179 comprising part of the second passageway 47 of the pressure vessel 15. An end cap 181 is secured to the bottom end of the matrix 177, and an end cap 183 is secured to the top end of the matrix 177. To secure the cartridge 16 inside the pressure vessel 15, the bowl 167 is provided with a stabilizing stub 175 formed in the bottom wall 169 of the bowl 167 that receives a recess 185 formed in the end cap 181 to prevent the cartridge 16 from swaying back and forth inside the pressure vessel 15 during use.

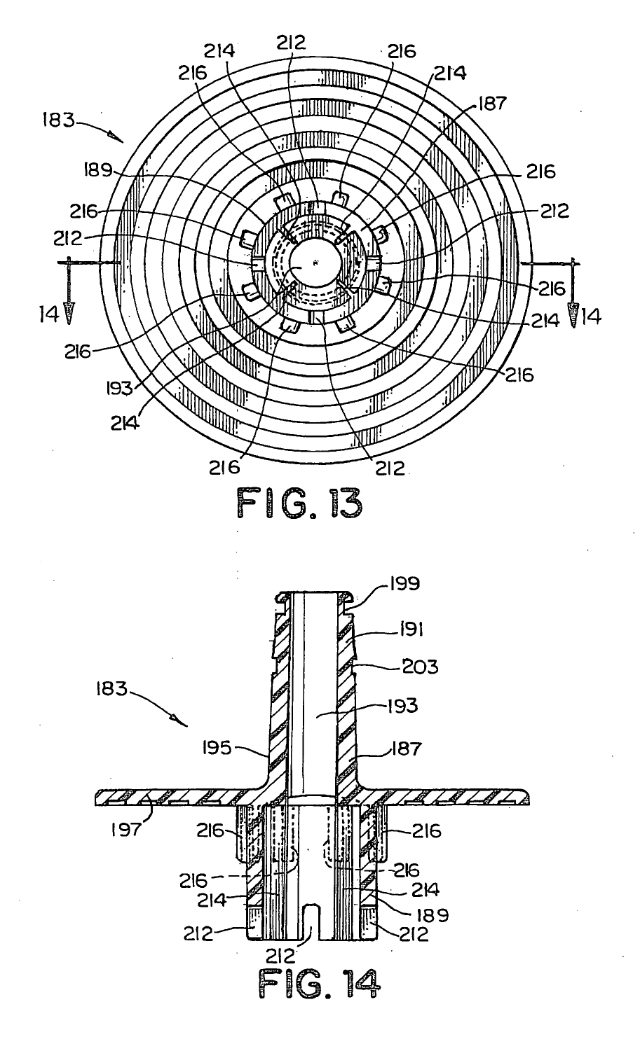

Referring to FIGS. 4, 12, 13, and 14, the end cap 183 comprises a hollow tube 187 having a first end portion 189, a second end portion 191, and a passageway 193 extending through the tube 187 from the first end portion 189 (where it receives fluid from the channel 179) to the second end portion 191, the passageway 193 also comprising part of the second passageway 47 of the pressure vessel 15. The tube 187 has an exterior surface portion 195 onto which is integrally formed therewith a flange portion 197 that engages the top end of the matrix 177. The tube 187 has an annular groove 199 formed at its second end portion 191 that receives an o-ring 201 for sealing between the tube 187 and the hollow cylindrical inlet port 55 to the second passageway 51 in the valve head 13 (thereby establishing a sealed connection between the outlet port 49 of the pressure vessel 15 and the inlet port 55 to the second passageway 51 in the valve head 13) when the pressure vessel 15 is connected to the valve head 13. Preferably, the second end portion 191 of the tube 187 is provided with an antimicrobial surface, such as by impregnating the second end portion 191 with antimicrobial materials such as those sold by AgION Technologies, Inc., of Wakefield, Mass.

The tube 187 also has another annular groove 203 formed in the second end portion 191 that receives a plurality of fingers or projections 205 (four fingers 205 being used in the embodiments of the invention shown in the drawings) integrally formed with the neck 59 and extending inwardly from the wall 59a of the neck 59 for positioning the tube 187 so that it extends along the central axis of the neck 59 and secures the cartridge 16 against both horizontal and vertical movement in the pressure vessel 15. Also, projections or lugs 207 are provided in the top wall 161 of the cover 159 which abut against the flange portion 197 of the end cap 183 to secure the cartridge 16 against vertical movement in the pressure vessel 15.

The groove 203 also receives the center portion of a flexible disc 209, that extends outwardly from the tube 187 and engages a portion of the neck 59 formed in the cover 159 to form a flapper valve 211 across the first passageway 45 of the pressure vessel 15. When fluid is flowing from upstream to downstream in the first passageway 45 of the pressure vessel 15, the fluid pushes against the flexible disc 209 causing it to flex in the downstream direction away from the neck wall 59a to open the first passageway 45 to permit fluid to flow into the pressure vessel 15. The flapper valve 211 prevents backflow of fluid from the first passageway 45 of the pressure vessel 15, because any flow of fluid back flowing from downstream to upstream in the first passageway 45 of the pressure vessel 15 pushes against the flexible disc 209 causing it to flex into engagement with the neck wall 59a formed in the cover 159 to close the flapper valve 211, thereby blocking backflow of fluid from the first passageway 45 of the pressure vessel 15.

Preferably, a compressible column 213, such as one made of a polyfoam material and preferably one comprising a polyfoam sealed compressible core column, is mounted in the pressure vessel 15, preferably by bonding the end portion of the column 213 in a receptacle 215 of the end cap 181, and the column 213 extends from the receptacle 215 into the channel 179 such that there is still space for fluid to flow through the channel 179 between the matrix 177 and the compressible column 213. The compressible column 213 provides protection against damage to the pressure vessel 15 and/or the matrix 177 if the fluid to be filtered and/or conditioned and/or purified freezes while in the pressure vessel 15, by providing space for the fluid to expand into if the fluid (for example, water) is the type of fluid that expands during freezing. The compressible column 213 also provides protection for the pressure vessel 15 against possible millisecond and microsecond pressure spikes.

Referring again to FIGS. 4, 12, 13, and 14, the tube 187 also has a plurality of fins or flanges 214 (four such fins 214 being used in the embodiments shown in the drawings) formed on its interior surface portion in the first end portion 189 of the tube 187 that extend inwardly into the passageway 193 towards its central axis. Fluid may flow along the passageway 193 past the fins 214. Further, the tube 187 is provided with a plurality of cutouts 212 (four such cutouts 212 being used in the embodiments shown in the drawings) made thereon to permit fluid that has been filtered and/or conditioned and/or purified in the pressure vessel 15 to flow into the tube 187 from the channel 179 through the cutouts 212. If the column 213 ever breaks loose from the receptacle 215 and abuts against the first end portion 189 of the tube 187, the fins 214 block the column 213 from entering the tube 187, and the cutouts 212 permit fluid to continue to flow into the tube 187 even if the column 213 abuts against the first end portion 189 of the tube 187.

The tube 187 also is provided with a plurality of ribs 216 (eight such ribs 216 being used in the embodiments shown in the drawings) formed in its first end portion 189 on the exterior surface portion 195 adjacent to the flange portion 197 for engaging the matrix 177 along a portion of the channel 179 extending therethrough and for centering the tube 187 in the channel 179.

The cover 159 and the bowl 167 preferably are made from a polymeric material, and after the cartridge 16 is positioned on the cover 159 and the bowl 167, the cover 159 and the bowl 167 are joined together along their respective rims 165 and 173, preferably by spin welding, to form a sealed seam portion 217.

Preferably, a reinforcement member 219 (FIG. 18) is secured around the pressure vessel 15, preferably around the side walls 163 and 171 of the pressure vessel 15 at and near the seam portion 217 of the pressure vessel 15 for reinforcing the pressure vessel 15, and preferably the seam portion 217 and the side walls 163 and 171 of the pressure vessel 15 at the seam portion 217. For example, the reinforcement member 219 may comprise fibers, such as carbon fibers or fiberglass or aramid fibers (e.g., Kevlar fibers) wrapped around the pressure vessel 15 and held together with epoxy or polyurethane or other binder. The reinforcement member 219 also may comprise reinforcing metal or other clamping device.

Referring to FIGS. 3, 6, and 1, preferably, a mounting bracket 221 is provided for mounting the valve head 13 in place where it is desired to be used. The mounting bracket 221 preferably has a plate 223 that connects to the valve head 13, and a flange portion 225 extending at a right angle from the end portion of the plate 223 having holes 227 extending therethrough that receive screws, threaded bolts, or the like for mounting the bracket 221 to the place where it is desired to use the valve head 13. In the embodiments of the invention shown in the drawings, the plate 223 has a ring-like portion 229 that sits on an annular ledge 231 formed in the outer periphery of the first end portion 233 of the valve head 13, and a cover plate 235, which has openings through the cover plate 235 to permit the shaft portions of the threaded bolts 12, the inlet port 19, the outlet port 53, and the first end portion 107 of the shaft 105 of the bypass valve 101 to pass through, is positioned over the first end portion 233 of the valve head 13 sandwiching the nubbin disc 111 and the ring-like portion 229 of the bracket 221 between the cover plate 235 and the first end portion 233 of the valve head 13. The cover plate 235 is secured by the threaded bolts 12 to the valve head 13. Because the ring-like portion 229 of the bracket 221 sits on the annular ledge 231 formed in the outer periphery of the first end portion 233 of the valve head 13, the valve head 13 may be rotated around its central axis within the ring-like portion 229 of the bracket 221 to facilitate connecting the inlet port 19 to the fluid transmission line and the outlet port 53 to the fluid receiving line.

Preferably, in addition to a height difference, a color-coded, snap-on ring 237 (FIGS. 1 and 12) is mounted around the outlet port 53 of the valve head 13 for distinguishing the outlet port 53 from the inlet port 19 of the valve head 13, to facilitate correct identification of the outlet port 53 so that the outlet port 53 is the port that is connected to the fluid receiving line.

In use, the pressure vessel 15 may be connected to the valve head 13 by rotating the pressure vessel 15 into the valve head 13 such that, in accordance with the first embodiment of the invention shown in the drawings, the pins 61 mounted on the valve head 13 move along the sloped grooves 57 formed on the neck 59 of the pressure vessel 15, until the pins 61 reach the second and portions 65 of the grooves 57 where the plungers 67 click into corresponding indents 94 indicating that the pressure vessel 15 has been properly connected to the valve head 13.

When the pressure vessel 15 has been connected to the valve head 13, the cam 75 aligned with the pin 79 pushes against the second end portion 83 of the pin 79 moving the pin 79 upstream in the first passageway 17 in the valve head 13, causing the first end portion 81 of the pin 79 to push the valve disc 33 off and substantially away from the valve seat 31 to open the valve 21 to permit fluid to flow through the valve 21 and the first passageway 17.

After flowing through the first passageway 17, the fluid exits the outlet port 41 of the first passageway 17 of the valve head 13 and enters the first passageway 45 formed in the pressure vessel 15 though the inlet port 43, and then moves along the first passageway 45 to the outside of the matrix 177 and then through the matrix 177 to the channel 179 of the second passageway 47 formed in the pressure vessel 15. Next, the fluid flows from the channel 179 into and through the passageway 193 formed in the tube 187, and exits the pressure vessel 15 from the outlet port 49 formed at the end of the tube 187 and enters into the second passageway 51 formed in the valve head 13 through the inlet port 55. Then, the fluid pushes the movable disc 33 of the second check valve 95 off the valve seat 31 of the second check valve 95 and moves it in a downstream direction away from the valve seat 31 of the second valve 95 to permit fluid to flow through the second valve 95 and through the second passageway 51 of the valve head 13 to a fluid receiving line connected to the outlet port 53.

Twisting the pressure vessel 15 off the valve head 13 discontinues flow of fluid through the first passageway 17 since the pin 79 is no longer being pushed by the pressure vessel 15 to lift the valve disc 33 of the valve 21 off the valve seat 31 of the valve 21 and the fluid flowing into the first passageway 17 pushes the valve disc 33 of the valve 21 back onto the valve seat 31 of the valve 21 to close valve 21.

Backflow of fluid from the second passageway 47 of the pressure vessel 13 is blocked by the check valve 95 since such backflow pushes the valve disc 33 of the valve 95 against the valve seat 31 of the valve 95 to close the valve 95.

Air contained in the apparatus 11 may escape through the automatic venting device 141. Such air may move into the fourth passageway 139 from outlet port 41, which may contain air when the pressure vessel 15 is being placed in service, and which may receive air from the passageway 17 of the valve head 13 and from the inlet port 43 of the pressure vessel 15 including air moving into the inlet port 43 from the pressure vessel 15. As fluid begins to flow through apparatus 11, the fluid pushes the air through the fourth passageway 139, around the ball 155 as the air is pushed through the automatic venting device 141, and out the outlet port 139b. As air is moved into the chamber 145, a portion of the air moves past the ball 155 by traveling along the cutouts 151 When the air that travels along the cutouts 151 reaches the end of the cutouts 151 and moves inwardly into the vent sleeve 143, the air hits the inwardly extending ledge 149 of the vent sleeve 143, rebounding off the ledge 149 back toward the ball 155 from downstream of the ball 155 to prevent the ball 155 from prematurely abutting against the o-ring 153 to close the fourth passageway 139 until most, if not all, of the air has been vented through the outlet port 139b. Although the preferred density of the ball 155 is slightly greater than the density of the fluid being filtered and/or conditioned and/or purified, the force/pressure of the fluid pushing against the ball 155 causes the ball 155 to be pressed into engagement with the o-ring 153 to close the outlet port 139b after the air has been vented through the outlet port 139b.

When it is desired to sanitize the fluid distribution system (e.g., an aircraft potable water distribution system) that the valve head 13 is connected to, the bypass valve 101 may be opened to permit any sanitizing fluid used to sanitize the fluid distribution system to flow from the fluid distribution system via the fluid transmission line to the valve head 13, through the valve head 13, and then back to the fluid distribution system via the fluid receiving line. The handle 115 of the bypass valve 101 may be turned to cause the second end portion 103 of the shaft 105 to move from the third passageway 99 to permit the sanitizing fluid entering the first passageway 17 to flow from the first passageway 17 into and through the third passageway 99, and then into the second passageway 51 downstream of the second check valve 95, and then back to the fluid distribution system via the fluid receiving line from outlet port 53. The check valve 95 prevents backflow of the sanitizing fluid into the second passageway 51 upstream of the check valve 95.

Preferably, when sanitizing fluid used to sanitize the fluid distribution system is being directed through valve head 13 by opening the bypass valve 101, the pressure vessel 15 is not connected to the valve head 13. With the pressure vessel 15 not connected to the valve head 13, the first check valve 21 is pushed closed by the sanitizing fluid entering the first passageway 17, and the sanitizing fluid flows through the valve head 13 as described above when the second end portion 103 has been removed from the third passageway 99, and then back into the fluid distribution system. However, even if the pressure vessel 15 is connected to the valve head 13 (thereby opening the first check valve 21) when sanitizing fluid is being directed through the valve head 13 by opening the bypass valve 101, a majority of the sanitizing fluid moves through the valve head 13 via the third passageway 99 as described above, rather than past the first check valve 21 to and through pressure vessel 15, and then from the pressure vessel 15 to and through the second passageway 51 of the valve head 13, because there is a substantially greater resistance to flow through the pressure vessel 15 due to the matrix 177 than there is for flow through an opened third passageway 99.

In a preferred embodiment of the invention relating to providing filtered and/or conditioned and/or purified water, especially purified water, from a potable water distribution system of, for example, an aircraft, valve heads 13 are installed locally at various cabin crew readily accessible service locations (service points) within galleys and lavatories of the aircraft, and the potable water distribution system is connected to each of the valve heads 13. Preferably, the valve heads 13 are positioned at or near where the water that is filtered and/or conditioned and/or purified in the pressure vessels 15 attached to the valve heads 13 is discharged from the potable water distribution system. With this arrangement, the valve head 13 may be easily accessed to install filtration/purification canisters (e.g., pressure vessels 15 each containing filtration/conditioning/purification means such as a cartridge 16, loose media, or the like) onto the valve heads 13, and to remove filtration/purification canisters (e.g., pressure vessels 15 each containing filtration/conditioning/purification means such as a cartridge 16, loose media, or the like) that have been used and install fresh canisters (e.g., pressure vessels 15 each containing filtration/conditioning/purification means such as a cartridge 16, loose media, or the like) in their place. Also, in contrast to prior art aircraft potable water distribution systems where water is passed through a cluster of more remote or centralized filters/purifiers to remove chlorine, foul tastes, and odors, and then sent along branches or legs of the potable water distribution system to be discharged from the branches or legs for use, possibly becoming contaminated from bacteria growing in the branches or legs, under this preferred embodiment of our invention, the water is filtered and/or conditioned and/or purified at or very near the point where it is discharged from the valve head 13 and actual used, thereby reducing the chances of contamination of the water after it has been filtered and/or conditioned and/or purified due to bacteria growing in the branches or legs or other possible contamination between the remote or centralized filters/purifiers and the point of discharge from the potable water distribution system. Further, when the valve heads 13 dispense water directly into an appliance, such as a coffee maker or hot water generating device for heating water for tea, access that contaminants have to the water after it has been filtered and/or conditioned and/or purified is even further limited.

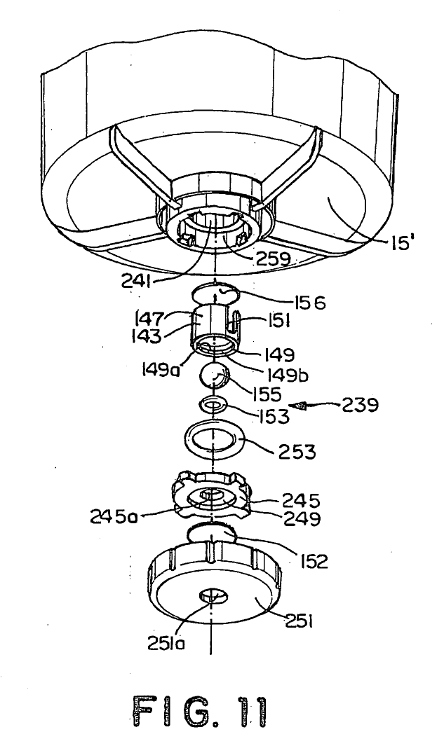

Turning now to FIGS. 10 and 11, there is shown an alternative embodiment of the invention. In this embodiment of the invention, the valve head 13 described above is mounted in an inverted position to that shown in the first embodiment of the invention to allow fluid to be directed downwardly such that the pressure vessel 15′ connected to the valve head 13 extends above rather than below the valve head 13. Pressure vessel 15′ is substantially the same as pressure vessel 15 described above, except pressure vessel 15′ is oriented neck-side down when connected to the valve head 13 and the pressure vessel 15′ is provided with an automatic venting device 239 for venting air and breaking any unwanted vacuum.

The pressure vessel 15′ is provided with a third passageway 241 extending through the bottom wall 169 of its bowl 167, and the automatic venting device 239 is positioned in the passageway 241. The automatic venting device 239 has substantially the same structure and operates the same way as the automatic venting device 141 described above. Like the automatic venting device 141, the automatic venting device 239 includes a vent sleeve 143 positioned in a chamber 243 formed along the third passageway 241. The vent sleeve 143 of the automatic venting device 239 has a cylindrical wall 147 having an inwardly extending ledge 149 formed at the downstream end portion of the vent sleeve 143, and a plurality of cutouts 151 (two being used in the vent sleeve 143 illustrated in FIGS. 10 and 11) formed in the wall 147 extending from the downstream end portion of the vent sleeve 143 toward the upstream end portion of the vent sleeve 143. The ledge 149 of the vent sleeve 143 has an upstream end portion 149a and a downstream end portion 149b, and each such end portion 149a and 149b preferably is chamfered. An o-ring 153 is positioned immediately downstream of the downstream end portion 149b of the ledge 149 and is blocked by the downstream end portion 149b of the ledge 149 from falling upstream into the chamber 243. A vent seal 245 sits over and against the o-ring 153, the vent seal 245 having a recess 247 that receives the downstream portion of the o-ring 153 and a central opening 245a extending through the vent seal 245 through which air from the third passageway 241 vents. The vent seal 245 preferably is provided with tabs 246 which are received by recesses 248 formed in the annular ridge 257 formed in the bowl 167 of the pressure vessel 15′. A ball 155 preferably having a density slightly greater than the density of the fluid (e., if water is the fluid, a preferred specific gravity for the ball 155 is about 1.1) is positioned in the vent sleeve 143 and permits venting of air and breaking of any unwanted vacuum until the fluid pushes the ball 155 into engagement with the o-ring 153 creating a seal between the ball 155 and the o-ring 153 and the o-ring 153 and the vent seal 245, thereby closing the third passageway 241.

The diameter of the third passageway 241 at the chamber 243 and the diameters of the cylindrical vent sleeve 143 and the ball 155 of the automatic venting device 239 are greater than the diameter of the third passageway 241 upstream of the chamber 243.

A screen 156, positioned in the chamber 243 upstream of the vent sleeve 143 of the automatic venting device 239, and a screen 152, positioned in a recess 249 formed in the downstream side end portion of the vent seal 245 and held therein by a vent cap 251 positioned thereover, are provided to reject possible interfering debris or particulates.

An o-ring 253 sits around an annular ridge 255 formed in the downstream side of the vent seal 245 to seal between the vent seal 245 and the annular ridge 257 formed in the bowl 167 of the pressure vessel 15′ that defines the outlet port 259 of the third passageway 241.

The vent cap 251, which has a central opening 251 a extending there through through which air from the third passageway 241 vents, is secured over the annular ridge 257 securing the screen 152 in the recess 249 of the vent seal 245, as well as securing the automatic venting device 239 in place in the third passageway 241.

The second embodiment of the invention facilitates providing fluid that has been filtered and/or conditioned and/or purified directly to a device in which the fluid is to be used, rather than providing the fluid to an intermediate location before it is subsequently transferred to the device in which the fluid is to be used. For example, if the fluid that is being filtered and/or conditioned and/or purified is water, rather than connecting the outlet port 53 of the valve head 13 to a water receiving line that leads to a water faucet in the galley of an airplane, drawing water from the faucet into a container, and pouring the water from the container into an apparatus, such as a coffee maker, that uses the water, the outlet port 53 may be connected directly down onto the coffee maker. Accordingly, with this setup, there is less of a chance that the water, which has been filtered and/or conditioned and/or purified by moving through the matrix 177, becomes contaminated from coming into contact with contaminants like bacteria after leaving the outlet port 53.

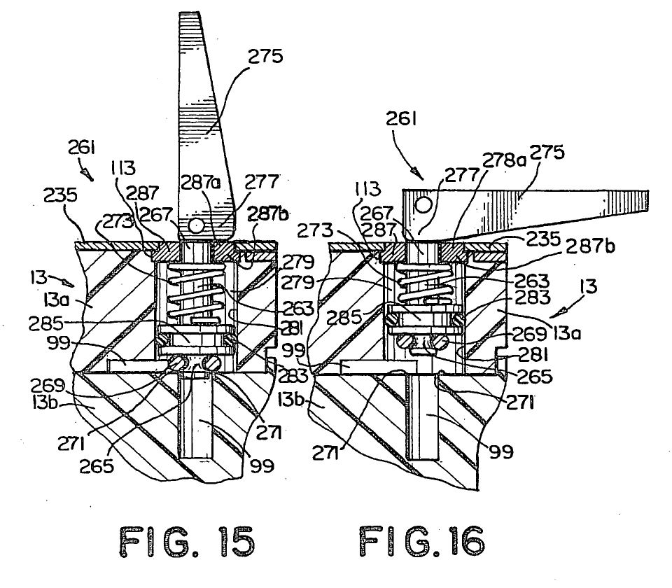

Turning now to FIGS. 15 and 16, there is shown an alternative embodiment of the bypass valve of the invention. Rather than using bypass valve 101 described above, a bypass valve 261 may be used. Like the bypass valve 101, the bypass valve 261 is positioned in the valve head 13 along the third passageway 99. The bypass valve 261 has a shaft 263 having a first end portion 265 and a second end portion 267. A sealing member 269, preferably an o-ring, is mounted on the first end portion 265 of the shaft 263 for sealing between the shaft 263 and a portion of the wall 271 of the third passageway 99 to sealing close the third passageway 99 when the first end portion 265 of the shaft 263 is positioned in the third passageway 99 such that the sealing member 269 is in sealing engagement with the third passageway wall 271. The bypass valve 261 has a biasing member 273, which preferably comprises a spring mounted around the shaft 263, for pushing the shaft 263 into the position shown in FIG. 15 that closes the third passageway 99. A handle 275 is pivotally mounted on the second end portion 267 of the shaft 263 and has a cam 277 formed thereon. When the handle 275 is positioned in a first position shown in FIG. 15, the biasing member 273 pushes the shaft 263 into a position that closes the third passageway. When the handle 275 is positioned in a second position, as shown in FIG. 16, by pivoting the handle 275 on its cam 277, the first end portion 265 of the shaft 263 is pulled into a position that opens the third passageway 99 by withdrawing the first end portion 265 of the shaft 263 from a blocking position in the third passageway 99, thereby permitting fluid to flow through the passageway 99.

The bypass valve 261 preferably is positioned in a bore 279 that extends through the first end member 13a of the valve head 13 and into engagement with the third passageway 99 formed in the valve head 13. An o-ring 283 is provided in an annular groove 285 that extends around the shaft 263 to seal between the shaft 263 and the wall 281 that forms the bore 279 to prevent fluid from escaping from the valve head 13 through the bore 279. To retain the bypass valve 261 within the bore 279, a plate 287, which has a first end portion 287a, a second end portion 287b, and an opening extending therethrough which the second end portion 267 of the shaft 263 extends, is positioned in the recess 113, and cover plate 235 is secured over the peripheral edge portion of the second end portion 287b of the plate 287. The first end portion 287a of the plate 287 projects into the opening in the cover plate 235 to provide a surface against which the handle 275 may be rotated on its cam 277.

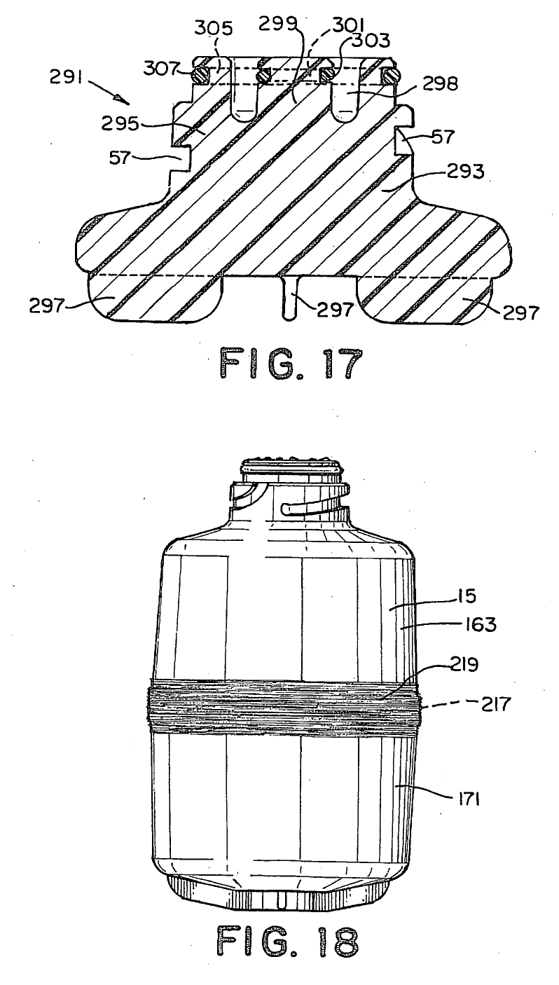

Preferably, an end cap 291 is provided, to be secured onto the valve head 13 when a pressure vessel 15 is not secured to the valve head 13 to maintain a sanitary condition inside the valve head by blocking dirt, debris, or other contaminants from having easy access to the second end portion 71 of the valve head 13, including the outlet port 41 from the first passageway 17 of the valve head 13 and the inlet port 55 to the second passageway 51 of the valve head 13. As shown in FIG. 17, preferably, the end cap 291 has a solid body 293 having a neck portion 295 formed on its first end portion for connecting the cap 291 onto the valve head 13 and four flanges 297 formed on its second end portion to facilitate gripping of the end cap 291 when rotating the end cap 291 into position on the valve head 13 and when rotating end cap 291 off of the valve head 13. Like the neck 59 of the pressure vessel 15, the neck portion 295 has three grooves 57 that receive the pins 61 of the valve head 13 when the end cap 291 is screwed onto the valve head 13. Alternatively, these grooves 57 and pins 61 may be replaced with threads formed on the outer surface of the neck portion 295 and matching threads formed on the valve head 13. The neck portion 295 also is provided with an annular recess 298 that defines a cylindrical column 299 that is received in the inlet port 55 of the second passageway 51 when the end cap 291 is secured onto the valve head 13. The cylindrical column 299 is provided with an annular groove 301 that extends around the column 299, and an o-ring 303 is positioned in the groove 301 for sealing between the column 299 and the inlet port 55 when the end cap 291 is secured onto the valve head 13. Also, an annular groove 305 is provided around the neck portion 295, and an o-ring 307 sits in the annular groove 305 for sealing between the neck portion 295 and the second end portion of the valve head 13. A further application of the end cap 291 is to block the flow of fluid from the first passageway 17 in the valve head 13 if it is desired to do so, such as in the event that the first check valve 21 is damaged or otherwise malfunctioning and does not close when the pressure vessel 15 is removed from the valve head 13.

Under the invention, water may be filtered and/or conditioned and/or purified at the point of use of the filtered and/or conditioned and/or purified water and at the time of use of the filtered and/or conditioned and/or purified water, significantly reducing chances of the filtered and/or conditioned and/or purified water becoming contaminated before it is used.

In addition to its applicability to aircraft potable water distribution systems, the invention may be applied in drinking water systems of recreational boats and yachts, commercial boats, recreational vehicles/caravans, residential homes, and water vending, cooling, warming and dispensing machines (such as those used in hospitals, schools, homes and factories). The invention also maybe applied to water systems in dental offices and laboratories.

The invention provides exceptional effectiveness (regarding water treatment results and cost effectiveness) and flexibility, and often weight reduction for aircraft and other uses with respect to providing filtered and/or conditioned and/or purified water. The apparatus 11 of the invention is easy to operate, requires little maintenance, and is dependable.

The apparatus 11 is very compact, light weight, long lasting, easily refurbished for extra-long service and embodies a slim-line design.

The filtration/purification canister (e.g., pressure vessel 15 containing filtration/conditioning/purification means such as a cartridge 16, loose media, or the like) may be provided with a light-weight composite construction. Due to its size/structure, the filtration/purification canister holds approximately 50% less unusable “transition water” (water retained in the canister necessary for the canister to function optimally) than prior art filters/purifiers, thereby making more of the water in the water distribution system available for use.

The invention provides point of use and time of use advantages. For instance, in an aircraft, the invention provides a potable water distribution system having valve heads 13 installed locally at various cabin crew readily accessible service locations or service points within galleys and lavatories of the aircraft, preferably at or near where water that is filtered and/or conditioned and/or purified is discharged from the potable water distribution system. Further, the invention provides for directly connecting the outlet port 53 of the valve head 13 to an appliance such as a coffee maker used in the aircraft galley, which reduces possible exposure of the filtered and/or conditioned and/or purified water to contaminants that may be encountered if such water were to be indirectly brought from the outlet port 53 of the valve head 13 to the appliance instead.

The invention provides for positioning the apparatus 11 of the invention in convenient, easily accessible locations. For instance, with respect to an aircraft water distribution system, in contrast to the prior art, the apparatuses are provided at various cabin crew readily accessible service locations in the galleys and lavatories of the aircraft at or near where water that is to be filtered and/or conditioned and/or purified is to be discharged from the potable water distribution system.

The cartridge 16 may be obtained from General Ecology, Inc., of Exton, Pennsylvania, and may be configured to provide what the user desires for optimum service related to the application. For instance, the cartridge 16 may be configured to provide microbiological purification as independently certified to now current EPA Protocol for Microbiological Purifiers, or to provide scale control and taste and odor removal, or to provide taste and odor removal along with larger pathogen removal, etc.

In accordance with the invention, antimicrobial surfaces may be provided to various components of the apparatus 11, such as to the tube 187, to assist in preventing backwards directed growth of bacteria, mildew and fungus into the canister, especially during short term periods of open non-use.

Backflow prevention provided in the valve head 13 prevents spillage from the valve head 13 when the canister is removed from the valve head 13. Further, this backflow prevention prevents reverse water flow into the purified/filtered water side of the canister.

The valve 211, which preferably is made from a flexible elastomeric material, helps prevent backflow from the canister, thereby limiting spillage when the canister is removed from the valve head 13.

Due to the two-piece construction of the body (first end member 1 3a and second end member 13b) of the valve head 13 and the simple means of holding the valve head 13 together, the valve head 13 may be easily disassembled and inexpensively refurbished for exceptionally long life using readily available hand tools, if necessary, with common replacement components to replace items such as o-rings, check valves, etc. Accordingly, the valve head 13 of the invention is long lasting.

The apparatus 11 of the invention is provided with an automatically venting feature for venting air and breaking vacuum in the apparatus 11.

In addition to being capable of being mounted such that the canister is positioned on the valve head 13 below the valve head 13, the valve head 13 may be mounted in an inverted position such that the outlet port 53 of the valve head 13 points downwardly to facilitate direct feed into appliances, such as coffee makers.

The apparatus 11 of the invention provides for exceptionally quick and easy one-handed canister changes by non-technical, untrained personnel.

Canisters (e.g., pressure vessels 15 each containing filtration/conditioning/purification means such as a cartridge 16, loose media, or the like) are disposable and can be completely incinerated. The pressure vessel 15 of the canister provides a barrier against contact with the internal, contaminated section of a used canister when it is being removed from the valve head and discarded.

The apparatus 11 is provided with an automatic valving features, which discontinues flow from the outlet port 41 of the valve head 13 when the canister is disconnected from the valve head 13, and that activates flow of fluid (e.g., water) through the valve head 13 into the canister when the canister is connected to the valve head 13.

A simple quarter turn of the manual bypass valve of the invention facilitates periodic overall sanitizing processes of the distribution system without removing canisters. The invention permits manual bypass with or without a canister in place on the valve head 13. Also, an individual apparatus 11 of a series of apparatuses 11 may be bypassed, if desired (such as when the individual apparatus 11 leads to a fluid receiving line that is leaking), by simply activating the bypass valve allowing continuing operation of the remainder of the water distribution system.

The canisters are protected from breaking if freezing occurs by the compressible column 213. Accordingly, draining of the canisters is not necessary if freezing temperatures exist. Further, the canisters function normally after thawing.

The canisters are heat resistant up to a survival temperature of 185° F. for two hours.

The bayonet-style canister mount with its “capture” positions provides tactile feedback via the spring plungers 67 that engage indents 94 formed in the neck 59 of the canister when the canister is properly seated on the valve head 13. The first check valves 21 is not activated (pushed into an open position) until the canister in proper position on the valve head 13.

Canisters (e.g., pressure vessels 15 each containing filtration/conditioning/purification means such as a cartridge 16, loose media, or the like) of the invention are ready to use immediately after being installed with normally minimal purge of water to expel air and small amounts of residual manufacturing materials.

The end cap 291, an optional feature, is available to protect the water distribution system from contaminants and debris when a canister is not installed on a valve head 13. The end cap 291 also provides a means to shut down a particular valve head 13 that it is connected to, while allowing uninterrupted use of the remainder of the water distribution system. It is NOT necessary to use the end cap 291 for disinfecting the system-the bypass valve is sufficient to avoid damaging the canister.

The valve head 13 may be rotated throughout 360° to accommodate installation constraints, and the valve head 13 may be installed with the valve head 13 being positioned above or below the canister.

Because the invention provides for easy, quick, and cost effective replacement of the filtration/purification canisters (pressure vessels 15 each containing a cartridge 16) onto the valve heads 13, preferably, the filtration/purification canisters (pressure vessels 15 each containing a cartridge 16) may be removed from the valve heads 13 and replaced with new filtration/purification canisters (pressure vessels 15 each containing a cartridge 16) before each flight of the aircraft or before the first flight of the day for the aircraft, to avoid using a contaminated or spent filtration/purification canisters (pressure vessels 15 each containing a cartridge 16). In contrast, due to the cost and difficulty of changing filtration/purification canisters in prior art systems, changes of filtration/purification canisters in prior art systems are not typically done more often than every 90 days or so by a maintenance crew.

1. An apparatus for filtering and/or conditioning and/or purifying a fluid, comprising
a valve head having a first passageway extending through it and being adapted to be connected to a fluid transmission line,
a first check valve positioned in the first passageway of the valve head for blocking flow of fluid through the first passageway when the valve is closed,
the first check valve including a valve housing, the valve housing having an annular ring having an annular inner wall surface, the annular inner wall surface having an annular ledge formed thereon creating a valve seat, and a movable valve disc contained within the valve housing that closes the first check valve when the valve disc rests against the valve seat and that permits flow of fluid through the first check valve when the valve disc is not resting against the valve seat, the valve disc having a guide pin formed on and extending upstream from its upstream face that is engaged by and slides in a guide pin holder to keep motion of the valve disc on a line that permits proper seating of the valve disc on the valve seat when the first check valve is closed, the guide pin holder being positioned upstream of the annular ring,
an outlet port formed at an outlet end portion of the first passageway in the valve head, a pressure vessel,
means positioned in the pressure vessel for filtering and/or conditioning and/or purifying a fluid,
the pressure vessel having an inlet port that is in fluid communication with the outlet port formed at the outlet end portion of the first passageway in the valve head when the pressure vessel is connected to the valve head,
the pressure vessel having a first passageway extending from the inlet port of the pressure vessel to the means for filtering and/or conditioning and/or purifying a fluid,
the pressure vessel having a second passageway extending from the means for filtering and/or conditioning and/or purifying a fluid to an outlet port of the pressure vessel,
the valve head having a second passageway extending through it and adapted to be connected to a fluid receiving line at an outlet port of the second passageway of the valve head,
the valve head having an inlet port formed at an inlet end portion of the second passageway of the valve head,
the inlet port formed at the inlet end portion of the second passageway in the valve head being in fluid communication with the outlet port of the pressure vessel when the pressure vessel is connected to the valve head,
connecting/disconnecting means formed on the valve head and the pressure vessel for connecting the pressure vessel to the valve head, when desired, to permit flow of fluid from the first passageway in the valve head to the inlet port of the pressure vessel, and for disconnecting the pressure vessel from the valve head, when desired, to stop flow of fluid from the first passageway of the valve head to the inlet port of the pressure vessel,
actuating means for automatically opening the first check valve in the valve head when the pressure vessel is connected to the valve head,
the actuating means including a pin positioned in the first passageway of the valve head between the valve disc and the outlet port at the outlet end portion of the first passageway of the valve head, the pin having a first end portion that engages the valve disc, and the pin having a second end portion,
the actuating means further including an end portion of the pressure vessel that engages the second end portion of the pin when the pressure vessel is connected to the valve head causing the pin to push against and lift the valve disc of the first check valve off the valve seat of the first check valve to open the first check valve, and
a second check valve positioned in the second passageway of the valve head for blocking backflow of fluid from the second passageway of the valve head when the pressure vessel is not connected to the valve head.

2. The apparatus of claim 1,
the second check valve including
a valve housing, the valve housing having an annular ring having an annular inner wall surface, the annular inner wall surface having an annular ledge formed thereon creating a valve seat, and
a movable valve disc contained in the housing that closes the second check valve when the valve disc rests against the valve seat and that permits flow of fluid through the second check valve when the valve disc is not resting against the valve seat, the valve disc having a guide pin formed on and extending downstream from its downstream face that is engaged by and slides in a guide pin holder to keep motion of the valve disc on a line that permits proper seating of the valve disc on the valve seat when the second check valve is closed, the guide pin holder being positioned downstream of the annular ring of the second check valve.

3. The apparatus of claim 1,
the valve head having a third passageway formed therein and extending from the first passageway at a position upstream of the first check valve to the second passageway downstream of the second check valve, and
a bypass valve positioned in the valve head that has a portion that when extended into the third passageway blocks flow of fluid through the third passageway and that when withdrawn from a blocking position in the third passageway opens the third passageway to permit fluid to flow therethrough.

4. The apparatus of claim 3,
the bypass valve including
a shaft having a first end portion, a second end portion, and threading on a portion of its length,
a thread engaging member secured on the valve head for engaging the threading of the shaft,
a handle mounted on the first end portion of the shaft for rotating the shaft in a first direction to move the second end portion of the shaft from the third passageway and for rotating the shaft in a direction opposite to the first direction to move the second end portion of the shaft into the third passageway, and
a sealing member mounted on the second end portion of the shaft.

5. The apparatus of claim 3,
the bypass valve including
a shaft having a first end portion and a second end porting,
a sealing member mounted on the first end portion of the shaft for sealing between the shaft and a portion of the third passageway wall to seal close the third passageway that the first end of the shaft is positioned in the third passageway,
a biasing member mounted on the shaft for pushing the shaft into a position that closes the third passageway, and
a handle pivotally mounted on the second end portion of the shaft, the handle having a cam formed thereon,
wherein when the handle is positioned in the first position, the biasing member pushes the shaft into a position that closes the third passageway, and when the handle is positioned in a second position by pivoting the handle on its cam, the first end portion is pulled into a position that opens the third passageway by withdrawing the first end portion of the shaft from a blocking position in the third passageway.

6. The apparatus of claim 1,
the valve head having a fourth passageway extending therethrough for venting purposes, the fourth passageway being defined by a wall,
an automatic venting/vacuum breaking device positioned in the fourth passageway for automatically venting air contained in the apparatus and for breaking any unwanted vacuum formed in the apparatus,
the automatic venting/vacuum breaking device including a vent sleeve positioned in a chamber formed along the fourth passageway, the vent sleeve having a downstream end portion and an upstream end portion, the vent sleeve having a cylindrical wall having an annular inwardly extending ledge formed at the downstream end portion of the vent sleeve, the vent sleeve having a plurality of cutouts in its cylindrical wall extending from the upstream end portion of the vent sleeve toward the downstream end portion of the vent sleeve, the ledge having an upstream side and a downstream side,
an o-ring seal positioned downstream of the ledge, and
a ball having a density slightly greater than the density of the fluid being filtered and/or conditioned and/or purified by the apparatus, the ball being positioned in the vent sleeve,
the venting/vacuum breaking device remaining in an open position until the ball is pushed by the fluid into engagement with a portion of the o-ring creating a seal between the ball and the o-ring and the o-ring and the portion of the fourth passageway wall, thereby closing the fourth passageway.

7. The apparatus of claim 1,
the connecting/disconnecting means comprising a twist-on structure.

8. The apparatus of claim 1,
the pressure vessel having a neck,
the connecting/disconnecting means comprising
a bayonet-style mount including a plurality pins mounted on the valve head, and a plurality of grooves formed on the neck, each groove having a first end portion where a corresponding pin from the plurality of pins mounted on the valve head may be inserted and moved along the groove by turning the pressure valve until a second end portion of the groove is reached, thereby securing the pressure vessel to the valve head.

9. The apparatus of claim 1,
the actuating means including a raised cam formed on the end portion of the pressure vessel that engages the second end portion of the pin when the pressure vessel is connected to the valve head causing the pin to push against and lift the valve disc of the first check valve off the valve seat of the first check valve to open the first check valve,

10. The apparatus of claim 8, further including
a plurality of indents formed in the end portion of the pressure vessel , and
a plurality of spring-loaded plungers mounted on the valve head which click into the corresponding indents and push against the end portion of the pressure vessel when the pressure vessel is connected to the valve head.

11. The apparatus of claim 1,
the pressure vessel comprising
a cover having a top wall, a side wall extending downwardly from the top wall, the side wall of the cover having a lower end portion, and a cover rim formed on the lower end portion of the side wall of the cover,
a bowl having a bottom wall, a side wall extending upwardly from the bottom wall, the side wall of the bowl having an upper end portion, and a bowl rim formed on the upper end portion of the side wall of the bowl,
the cover rim and the bowl rim being joined together to form a sealed seam portion of the pressure vessel, and
a reinforcement member secured around the pressure vessel for reinforcing the pressure vessel.

12. The apparatus of claim 11,
the reinforcement member comprising a metal ring or a metal clamp or carbon, fiberglass, aramid or other suitable fibers or materials wrapping around the pressure vessel.

13. The apparatus of claim 1,
the pressure vessel including a compressible column mounted therein and substantially surrounded by the means for filtering and/or conditioning and/or purifying a fluid for accommodating possible expansion of the fluid,
the compressible column protecting against damage to the pressure vessel and/or means for filtering and/or conditioning and/or purifying a fluid caused by freezing if the fluid freezes and expands in the pressure vessel by providing space, for fluid to expand , the fluid expanding into and comprising the compressible column as the fluid freezes.

14. The apparatus of claim 13,
the outlet port of the pressure vessel including a tube having a first end portion, a second end portion, and a passageway extending through the tube from a first end of the tube to a second end of the tube through which fluid that has been filtered and/or conditioned and/or purified in
the pressure vessel moves to exit the pressure vessel,
the tube having an interior surface portion and an exterior surface portion, the tube having a plurality of fins formed on the interior surface portion of the tube at the first end portion of the tube, the fins extending inwardly into the passageway of the tube and being oriented to extend parallel to a center axis of the tube for blocking the compressible column from entering the tube and plugging the passageway extending there through if the compressible column inadvertently breaks loose from where it is mounted in the pressure vessel, and
the tube at its first end portion having a plurality of cutouts made therein to permit flow of fluid that has been filtered and/or conditioned and/or purified in the pressure vessel to continue to enter the tube if the compressible column breaks loose from where it is mounted in the pressure vessel and abuts against the first end of the tube.

15. The apparatus of claim 1,
the outlet port of the pressure vessel including a tube having a passageway extending through the tube through which fluid that has been filtered and/or conditioned and/or purified moves to exit the pressure vessel,
the tube having an exterior surface portion, and
the exterior surface portion having an annular groove formed therein,
the pressure vessel further including
a flapper valve for reducing/preventing backflow of fluid from the inlet port of the pressure vessel,
the flapper valve comprising a flexible disc mounted on the tube in the annular groove formed on the tube, the flexible disc having a central opening formed therein through which the tube extends,
the flexible disc extending across the first passageway of the pressure vessel,
the flexible disc flexing in a first direction to open the first passageway of the pressure vessel when pushed by inbound fluid entering the pressure vessel to permit inbound flow of fluid to pass it as inbound fluid flows through the first passageway of the pressure vessel, and
the flexible disc flexing in a second direction to abut against a portion of an interior wall of the pressure vessel along the first passageway of the pressure vessel to close the first passageway of the pressure vessel when pushed by a back flow of fluid from the pressure vessel along the first passageway of the pressure vessel.

16. The apparatus of claim 1,
the pressure vessel having a bottom wall having a passageway extending through it for venting purposes, the passageway being defined by a wall,
an automatic venting device positioned in the passageway for automatically venting air and for breaking any unwanted vacuum,
the automatic venting device including a vent sleeve positioned in a chamber formed in the passageway, the vent sleeve having a downstream end portion and an upstream end portion, the vent sleeve having a cylindrical wall having an annular inwardly extending ledge formed at the downstream end portion of the vent sleeve, the vent sleeve having a plurality of cutouts in its cylindrical wall extending from the upstream end portion of the vent sleeve toward the downstream end portion of the vent sleeve, the ledge having an upstream side and a downstream side,
means positioned downstream of the ledge for creating a valve seat and for sealing between the valve seat and the wall of the passageway, and
a ball having a density slightly greater than the density of the fluid being filtered and/or conditioned and/or purified, the ball being positioned in the vent sleeve,
the venting device remaining in an open position until the ball is pushed by the fluid into engagement with the valve seat to close the passageway.

17. The apparatus of claim 1, further including
a color-coded, snap-on ring mounted around an outlet port formed at an outlet portion of the second passageway in the valve head to assist in distinguishing such outlet port from an inlet port formed at an inlet portion of the first passageway in the valve head.

18. An automatic valving device for a pressure vessel that holds means for filtering and/or conditioning and/or purifying a fluid, comprising
a body having a first passageway extending through it and being adapted to be connected to a fluid transmission line,
a first check valve positioned in the first passageway of the body for blocking flow of fluid through the first passageway when the valve is closed,
an outlet port formed at an outlet end portion of the first passageway in the body,
the body having a second passageway extending through it and adapted to be connected to a fluid receiving line at an outlet port of the second passageway of the body,
the body having an inlet port formed at an inlet end portion of the second passageway of the body,
the inlet port formed at the inlet end portion of the second passageway in the body being in fluid communication with the outlet port of the pressure vessel when the pressure vessel is connected to the body,
connecting/disconnecting means formed on the body for connecting the body to the pressure vessel, when desired, to permit flow of fluid from the first passageway in the body to the pressure vessel, and for disconnecting the body from the pressure vessel, when desired, to stop flow of fluid from the first passageway of the body to the pressure vessel,
actuating means for automatically opening the first check valve in the body when the pressure vessel is connected to the body,
a second check valve positioned in the second passageway of the body for blocking backflow of fluid from the second passageway of the body when the pressure vessel is not connected to the body,
the body having a third passageway formed therein and extending from the first passageway at a position upstream of the first check valve to the second passageway downstream of the second check valve, and
a bypass valve positioned in the body that has a portion that when extended into the third passageway blocks flow of fluid through the third passageway and that when withdrawn from a blocking position in the third passageway opens the third passageway to permit fluid to flow therethrough.

19. The device of claim 18,
the bypass valve including
a shaft having a first end portion, a second end portion, and threading on a portion of its length,
a thread engaging member secured on the body for engaging the threading of the shaft,
a handle mounted on the first end portion of the shaft for rotating the shaft in a first direction to move the second end portion of the shaft from the third passageway and for rotating the shaft in a direction opposite to the first direction to move the second end portion of the shaft into the third passageway, and
a sealing member mounted on the second end portion of the shaft.

20. The device of claim 18, the bypass valve including
a shaft having a first end portion and a second end porting,
a sealing member mounted on the first end portion of the shaft for sealing between the shaft and a portion of the third passageway wall to sealingly close the third passageway that the first end of the shaft is positioned in the third passageway,
a biasing member mounted on the shaft for pushing the shaft into a position that closes the third passageway, and
a handle pivotly mounted on the second end portion of the shaft, the handle having a cam formed thereon,
wherein when the handle is positioned in the first position, the biasing member pushes the shaft into a position that closes the third passageway, and when the handle is positioned in a second position by pivoting the handle on its cam, the first end portion is pulled into a position that opens the third passageway by withdrawing the first end portion of the shaft from a blocking position in the third passageway.

21. The device of claim 18,
the body having a fourth passageway extending therethrough for venting purposes, the fourth passageway being defined by a wall,
an automatic venting/vacuum breaking device positioned in the fourth passageway for automatically venting air and for breaking any unwanted vacuum,
the automatic venting/vacuum breaking device including a vent sleeve positioned in a chamber formed along the fourth passageway, the vent sleeve having a downstream end portion and an upstream end portion, the vent sleeve having a cylindrical wall having an annular inwardly extending ledge formed at the downstream end portion of the vent sleeve, the vent sleeve having a plurality of cutouts in its cylindrical wall extending from the upstream end portion of the vent sleeve toward the downstream end portion of the vent sleeve, the ledge having an upstream side and a downstream side,
an o-ring seal positioned downstream of the ledge, and
a ball having a density slightly greater than the density of the fluid being filtered and/or conditioned and/or purified, the ball being positioned in the vent sleeve,
the venting/vacuum breaking device remaining in an open position until the ball is pushed by the fluid into engagement with a portion of the o-ring creating a seal between the ball and the o-ring and the o-ring and a portion of the fourth passageway wall, thereby closing the fourth passageway.

22. An automatic valving device for a pressure vessel that holds means for filtering and/or conditioning and/or purifying a fluid, comprising
a body having a first passageway extending through it and being adapted to be connected to a fluid transmission line,
a first check valve positioned in the first passageway of the body for blocking flow of fluid through the first passageway when the valve is closed,
an outlet port formed at an outlet end portion of the first passageway in the body,
the body having a second passageway extending through it and adapted to be connected to a fluid receiving line at an outlet port of the second passageway of the body,
the body having an inlet port formed at an inlet end portion of the second passageway of the body,
the inlet port formed at the inlet end portion of the second passageway in the body being in fluid communication with the outlet port of the pressure vessel when the pressure vessel is connected to the body,
connecting/disconnecting means formed on the body for connecting the body to the pressure vessel, when desired, to permit flow of fluid from the first passageway in the body to the pressure vessel, and for disconnecting the body from the pressure vessel, when desired, to stop flow of fluid from the first passageway of the body to the pressure vessel,
actuating means for automatically opening the first check valve in the body when the pressure vessel is connected to the body,
a second check valve positioned in the second passageway of the body for blocking backflow of fluid from the second passageway of the body when the pressure vessel is not connected to the body,
the body having a fourth passageway extending therethrough for venting purposes, the fourth passageway being defined by a wall,
an automatic venting/vacuum breaking device positioned in the fourth passageway for automatically venting air and for breaking any unwanted vacuum,
the automatic venting/vacuum breaking device including a vent sleeve positioned in a chamber formed along the fourth passageway, the vent sleeve having a downstream end portion and an upstream end portion, the vent sleeve having a cylindrical wall having an annular inwardly extending ledge formed at the downstream end portion of the vent sleeve, the vent sleeve having a plurality of cutouts in its cylindrical wall extending from the upstream end portion of the vent sleeve toward the downstream end portion of the vent sleeve, the ledge having an upstream side and a downstream side,
an o-ring seal positioned downstream of the ledge, and
a ball having a density slightly greater than the density of the fluid being filtered and/or conditioned and/or purified, the ball being positioned in the vent sleeve,
the venting device/vacuum breaking remaining in an open position until the ball is pushed by the fluid into engagement with a portion of the o-ring creating a seal between the ball and the o-ring and the o-ring and a portion of the fourth passageway wall, thereby closing the fourth passageway.

23. A pressure vessel for filtering and/or conditioning and/or purifying a fluid, comprising
a cover having a top wall, a side wall extending downwardly from the top wall, the side wall of the cover having a lower end portion, and a cover rim formed on the lower end portion of the side wall of the cover,
a bowl having a bottom wall, a side wall extending upwardly from the bottom wall, the side wall of the bowl having an upper end portion, and a bowl rim formed on the upper end portion of the side wall of the bowl,
the cover rim and the bowl rim being joined together to form a sealed seam portion of the pressure vessel,
means positioned in the pressure vessel for filtering and/or conditioning and/or filtering the fluid, and
a compressible column mounted in the pressure vessel,
the compressible column protecting against damage to the pressure vessel and/or means for filtering and/or conditioning and/or purifying a fluid caused by freezing if the fluid freezes and expands in the pressure vessel and for mitigating possible millisecond and /or microsecond pressure spikes by providing space, for fluid to expand into.

24. The pressure vessel of claim 23, further including
a reinforcement member secured around the pressure vessel for reinforcing the pressure vessel.

25. The pressure vessel of claim 23,
the outlet port of the pressure vessel including a tube having a passageway extending through the tube through which fluid that has been filtered and/or conditioned and/or purified moves to exit the pressure vessel,
the tube having an exterior surface portion, and
the exterior surface portion having an annular groove formed therein,
the pressure vessel further including
a flapper valve for reducing possible backflow of fluid from the inlet port of the pressure vessel,
the flapper valve comprising a flexible disc mounted on the tube in the annular groove formed on the tube, the flexible disc having a central opening formed therein through which the tube extends,
the flexible disc extending across the first passageway of the pressure vessel,
the flexible disc flexing in a first direction to open the first passageway of the pressure vessel when pushed by inbound fluid entering the pressure vessel to permit inbound flow of fluid to pass it as inbound fluid flows through the first passageway of the pressure vessel, and
the flexible disc flexing in a second direction to abut against a portion of an interior wall of the pressure vessel along the first passageway of the pressure vessel to close the first passageway of the pressure vessel when pushed by a back flow of fluid from the pressure vessel along the first passageway of the pressure vessel.

26. The pressure vessel of claim 23,
the bottom wall of the bowl having a passageway extending therethrough for venting purposes, the passageway being defined by a wall,
an automatic venting/vacuum breaking device positioned in the passageway for automatically venting air and for breaking any unwanted vacuum,
the automatic venting/vacuum breaking device including a vent sleeve positioned in a chamber formed in the passageway, the vent sleeve having a downstream end portion and an upstream end portion, the vent sleeve having a cylindrical wall having an annular inwardly extending ledge formed at the downstream end portion of the vent sleeve, the vent sleeve having a plurality of cutouts in its cylindrical wall extending from the upstream end portion of the vent sleeve toward the downstream end portion of the vent sleeve, the ledge having an upstream side and a downstream side,
means positioned downstream of the ledge for creating a valve seat and for sealing between the valve seat and the wall of the passageway, and
a ball having a density slightly greater than the density of the fluid being filtered and/or conditioned and/or purified, the ball being positioned in the vent sleeve,
the venting/vacuum breaking device remaining in an open position until the ball is pushed by the fluid into engagement with the valve seat to close the passageway.

27. A pressure vessel for filtering and/or conditioning and/or purifying a fluid, comprising
a cover having a top wall, a side wall extending downwardly from the top wall, the side wall of the cover having a lower end portion, and a cover rim formed on the lower end portion of the side wall of the cover,
a bowl having a bottom wall, a side wall extending upwardly from the bottom wall, the side wall of the bowl having an upper end portion, and a bowl rim formed on the upper end portion of the side wall of the bowl,
the cover rim and the bowl rim being joined together to form a sealed seam portion of the pressure vessel,
means positioned in the pressure vessel for filtering and/or conditioning and/or filtering the fluid, and
the bottom wall of the bowl having a passageway extending therethrough for venting purposes, the passageway being defined by a wall,
an automatic venting/vacuum breaking device positioned in the passageway for automatically venting air and for breaking any unwanted vacuum,
the automatic venting/vacuum breaking device including a vent sleeve positioned in a chamber formed in the passageway, the vent sleeve having a downstream end portion and an upstream end portion, the vent sleeve having a cylindrical wall having an annular inwardly extending ledge formed at the downstream end portion of the vent sleeve, the vent sleeve having a plurality of cutouts in its cylindrical wall extending from the upstream end portion of the vent sleeve toward the downstream end portion of the vent sleeve, the ledge having an upstream side and a downstream side,
means positioned downstream of the ledge for creating a valve seat and for sealing between the valve seat and the wall of the passageway, and
a ball having a density slightly greater than the density of the fluid being filtered and/or conditioned and/or purified, the ball being positioned in the vent sleeve,
the venting device/vacuum breaking remaining in an open position until the ball is pushed by the fluid into engagement with the valve seat to close the passageway.

28. An automatic air vent valving apparatus that opens to permit air to vent from a device and that closes after the air has been vented from the device, comprising
a ball
a vent sleeve for receiving the ball, the vent sleeve having a downstream end portion and an upstream end portion,
means when positioned downstream of the vent sleeve for forming a valve seat that receives a portion of the ball to close the air vent valving apparatus, and
air directing means formed in the vent sleeve for directing air being vented past the ball and then back toward the ball to prevent the ball from prematurely abutting against the valve seat until most, if not all, of the air has been vented.

29. The automatic air vent valving apparatus of claim 28,
the air directing means including
a plurality of cutouts formed in the vent sleeve and extending from the upstream end portion of the vent sleeve toward the downstream end portion of the vent sleeve which direct air to move along past the ball, and
an annular inwardly extending flange formed on the downstream end portion of the vent sleeve which directs air that has moved past the ball to rebound off back toward the ball.

30. A method for providing filtered and/or conditioned and/or purified water from a potable water distribution system, comprising the steps of
providing a valve head, the valve head having a first passageway extending through it and being adapted to be connected to a water transmission line, a first check valve positioned in the first passageway of the valve head for blocking flow of water through the first passageway when the valve is closed, an outlet port formed at an outlet end portion of the first passageway in the valve head the connects to an inlet port of a pressure vessel, a second passageway extending through the valve head and adapted to be connected to a water receiving line at an outlet port of the second passageway of the valve head, an inlet port formed at an inlet end portion of the second passageway of the valve head that connects to an outlet port of a pressure vessel, actuating means for automatically opening the first check valve in the valve head when a pressure vessel is connected to the valve head, a second check valve positioned in the second passageway of the valve head for blocking backflow of water from the second passageway of the valve head when the pressure vessel is not connected to the valve head, a third passageway extending from the first passageway upstream from the first check valve to the second passageway downstream from the second check valve, and the valve head having a bypass valve positioned in the third passageway,
connecting a pressure vessel to the valve head when it is desired to filter and/or condition and/or purify water by causing the water to flow through the pressure vessel, the pressure vessel having means positioned therein for filtering and/or conditioning and/or purifying water,
automatically triggering the actuating means of the valve head to automatically open the first check valve in the valve head when the pressure vessel is connected to the valve head to permit water to flow from the first passageway of the valve head to the pressure vessel, then through the pressure vessel, then from the pressure vessel to and through the second passageway of the valve head, and then from the outlet port of the second passageway of the valve head to the water receiving line, and
when it is desired to sanitize the potable water distribution system,
opening the bypass valve, and
flowing sanitizing fluid through the potable water distribution system and the valve head to sanitize the system.

31. The method of claim 30, further including the step of
directing the water that has been filtered and/or conditioned and/or purified in the pressure vessel from the outlet port of the second passageway of the valve head directly to an appliance that uses the water to reduce possible exposure to contaminants that may be encountered if the water were to be indirectly brought to the appliance instead.

32. A method for providing filtered and/or conditioned and/or purified water from a potable water distribution system of an aircraft, comprising the steps of
mounting valve heads at various cabin crew readily accessible service locations within galleys and lavatories of the aircraft at or near where water that is to be filtered and/or conditioned and/or purified is to be discharged from the potable water distribution system, each valve head having a first check valve positioned therein, and
connecting the potable water distribution system of the aircraft to the valve heads,
the valve heads being capable of having filtration/purification canisters connected thereto using an easy twist-on motion,
the valve heads being capable of having filtration/purification canisters removed therefrom using an easy twist-on motion,
the filtration/purification canisters automatically opening the first check valves in the valve heads when the filtration/purification canisters and from the filtration/purification canisters back to and through the valve heads to outlet ports from the valve heads, and
the first check valves in the valve heads automatically closing when the filtration/purification canisters are disconnected from the valve heads to stop water from flowing past the first check valves.

33. The method of claim 32, further including the step of
connecting one an outlet port of at least one of the valve heads directly to an appliance that uses the water to reduce possible exposure to contaminants that may be encountered if water were to be indirectly brought from the outlet port of the valve head to the appliance instead.
